(19) United States
(12) Patent Application Publication
(10) Pub. No.: US 2026/0290373 A1
(43) Pub. Date: Sep. 24, 2026

(54) SYSTEM

(71) Applicant: SoftBank Group Corp., Tokyo (JP)

(72) Inventor: Toshiki MATSUMURA, Tokyo (JP)

(73) Assignee: SoftBank Group Corp., Tokyo (JP)

(21) Appl. No.: 19/563,082

(22) Filed: Mar. 11, 2026

(30) Foreign Application Priority Data
Mar. 19, 2025 (JP) 2025-044999

(51) Int. Cl. G10L 25/60; G06F 40/186; G06F 40/40; G10L 15/26; G10L 25/63

(52) U.S. Cl. CPC G10L 25/60; G06F 40/186; G06F 40/40; G10L 15/26; G10L 25/63

(57) ABSTRACT

A system includes a processor that is configured to provide an interface through which a user inputs user information materials and audio data, analyze the input user information materials and the audio data and numericalize volume information and emotion information from the audio data, and generate a prompt that instructs a generative artificial intelligence model to generate feedback regarding content and speaking style based on an analysis result of the user information materials and the audio data.

### CROSS-REFERENCE TO RELATED APPLICATION

This application is based on and claims priority under 35 USC 119 from Japanese Patent Application No. 2025-044999 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional presentation support tools primarily focus on static aspects of presentation materials, such as grammar checking, spell checking, slide layout, and structural suggestions, and therefore fail to provide integrated guidance that also reflects how a user actually speaks during a presentation. In particular, such conventional tools do not adequately capture and analyze acoustic characteristics of a user's speech, including volume patterns, speaking speed, and emotional expressions, and do not sufficiently utilize these characteristics when generating feedback. As a result, a user has difficulty understanding which parts of the presentation content and which aspects of the speaking style should be improved, and cannot efficiently enhance overall presentation performance. Furthermore, existing systems that partially analyze audio often provide only low-level metrics and do not leverage generative artificial intelligence models to produce high-quality, context-aware feedback that connects the content of the materials with the real delivery. Therefore, there is a need for a system that can accept user information materials and audio data, analyze both textual and acoustic features, numericalize volume and emotion information, and then use a generative artificial intelligence model to generate comprehensive feedback regarding both presentation content and speaking style.

### SUMMARY

In order to solve the above-described problems, an embodiment of the present invention provides a system comprising a processor, wherein the processor is configured to provide an interface through which a user inputs user information materials and audio data, analyze the input user information materials and the audio data and numericalize volume information and emotion information from the audio data, and generate a prompt that instructs a generative artificial intelligence model to generate feedback regarding content and speaking style based on an analysis result of the user information materials and the audio data. The processor is further configured to recognize an emotion of the user from the audio data and track a change of the emotion by evaluating an emotional state in real time using an emotion engine, thereby enabling more detailed and time-resolved assessment of the user's delivery. In addition, the processor is configured to transmit generated feedback to a terminal and cause the terminal to display the generated feedback to the user, so that the user can immediately review and utilize the feedback for revising the information materials and adjusting the speaking style. By these means, the system realizes integrated, iterative presentation support that combines analysis of textual content, acoustic features, and emotional states with generative artificial intelligence-based feedback generation.

The term “system” refers to a combination of hardware and software components, including at least one processor and associated memories, interfaces, and communication mechanisms, configured to execute the functions described in the claims.

The term “processor” refers to any computing element, such as a central processing unit (CPU), graphics processing unit (GPU), digital signal processor (DSP), microcontroller, or a combination thereof, capable of executing instructions to perform the processing operations described in the claims.

The term “interface” refers to a hardware and/or software mechanism, such as a graphical user interface, application programming interface, web interface, or input/output module, through which a user or an external device provides data to or receives data from the system. The term “user information materials” refers to electronic data representing information prepared by a user for presentation or communication purposes, including but not limited to text data, slide contents, scripts, notes, or document files describing the intended content of a presentation.

The term “audio data” refers to digital representations of sound captured from the user, typically including the user's speech during a presentation or rehearsal, encoded in any suitable audio format such as PCM, WAV, MP3, or similar formats.

The term “analyze” refers to processing operations performed by the processor to interpret, extract, or derive information from user information materials and audio data, which may include parsing, pattern recognition, feature extraction, classification, or statistical evaluation.

The term “numericalize” refers to converting qualitative or continuous audio characteristics, including volume information and emotion-related signals, into quantitative values or numerical feature vectors suitable for computational processing and evaluation by the system.

The term “volume information” refers to data representing the loudness or amplitude characteristics of the audio data over time, including, for example, sound pressure levels, normalized intensity values, or other measures of audio signal strength.

The term “emotion information” refers to data that characterizes an emotional state inferred from the audio data, such as levels or probabilities of emotions including neutrality, happiness, excitement, sadness, anger, or other affective states, represented in a quantitative or categorical form.

The term “prompt” refers to a structured input, instruction set, or message generated by the processor and provided to a generative artificial intelligence model, specifying context, analysis results, and desired outputs in order to cause the generative artificial intelligence model to generate corresponding feedback.

The term “generative artificial intelligence model” refers to a machine learning model, such as a neural network-based language model or multimodal model, configured to generate text or other content in response to a given input or prompt, and capable of producing feedback regarding presentation content and speaking style.

The term “feedback regarding content” refers to generated information that evaluates or suggests improvements for the substance of the user information materials, including aspects such as clarity of main points, logical structure, persuasiveness, completeness of explanation, and appropriateness of examples or supporting data.

The term “feedback regarding speaking style” refers to generated information that evaluates or suggests improvements for the manner in which the user delivers the presentation, including aspects such as voice volume, speaking speed, intonation, rhythm, emphasis, and emotional expression.

The term “emotion engine” refers to a software and/or hardware module that processes audio data to estimate an emotional state of the user, using techniques such as signal processing, feature extraction, and machine learning-based classification, and outputs corresponding emotion-related information.

The term “emotional state” refers to an inferred condition representing how the user is feeling or expressing affect at a given time during speech, such as neutral, positive, negative, excited, calm, or similar affective categories.

The term “real time” refers to processing that is performed substantially concurrently with or with only a short delay relative to the reception of audio data, such that the emotional state and its changes can be evaluated while the user is speaking or immediately thereafter.

The term “terminal” refers to an electronic device operated by the user, such as a personal computer, smartphone, tablet, or dedicated presentation device, capable of communicating with the system, sending user information materials and audio data, and receiving and displaying feedback.

The term “generated feedback” refers to the output produced by the generative artificial intelligence model in response to the prompt produced by the processor, including at least one of qualitative comments, suggestions, evaluations, ratings, or guidance regarding presentation content and speaking style.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### FIRST EXEMPLARY EMBODIMENT

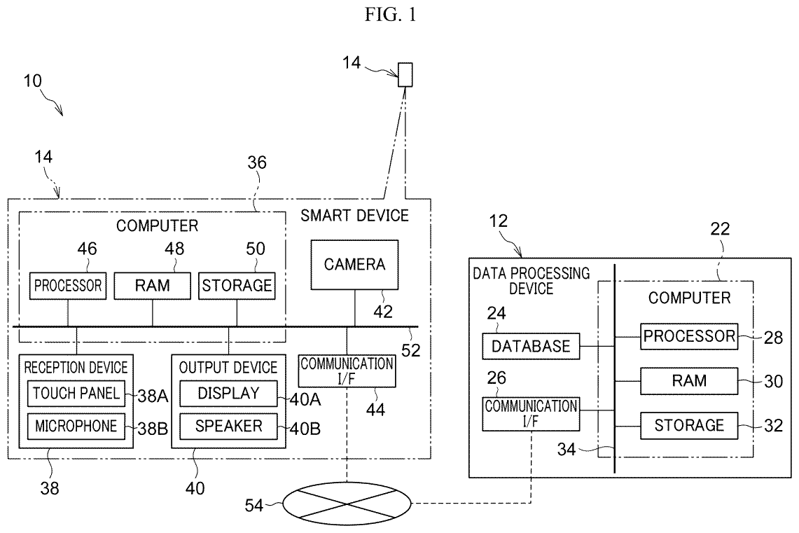

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

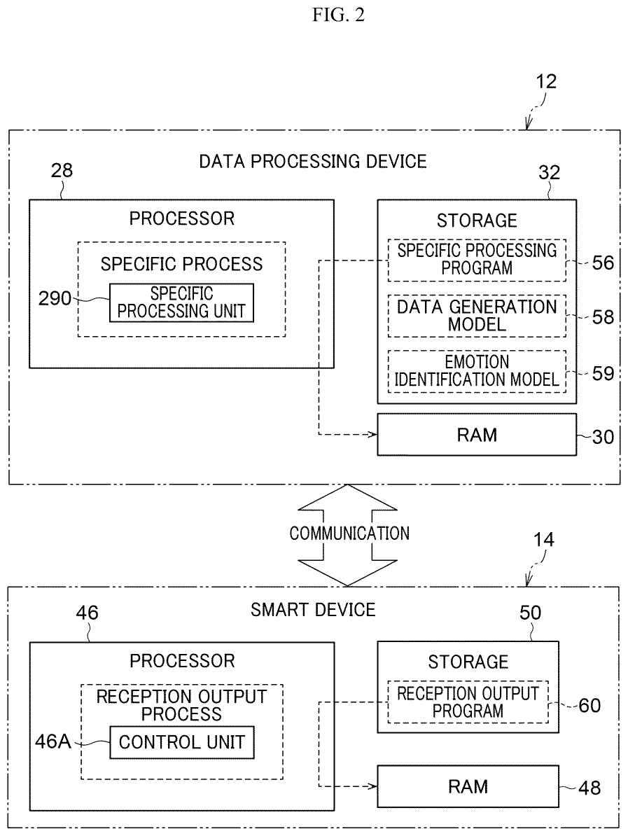

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional presentation support tools mainly focus on static content such as slide layout or wording, and offer only coarse or qualitative feedback on a presenter's delivery. In particular, existing systems that analyze recorded presentations typically (i) treat speech recognition, acoustic analysis, and feedback generation as independent and loosely coupled processes, (ii) do not generate a machine-usable, structured numerical representation that jointly encodes volume characteristics and emotion characteristics over time, and (iii) do not tightly integrate such numerical representations with textual materials in a way that can be effectively consumed by a generative AI model through a precisely constructed prompt sentence.

As a result, conventional systems suffer from several technical limitations. First, they are unable to systematically combine heterogeneous data types-prepared text materials, recognized speech text, and time-varying acoustic and emotional features-into a unified representation that a computation engine can process deterministically. Second, they cannot provide consistent, repeatable feedback quality because the input to any AI component is often unstructured or incomplete, leading to non-deterministic or shallow analysis. Third, existing architectures do not exploit the temporal structure of emotional states and volume variations in a way that allows a downstream model to track and evaluate presentation dynamics over the entire rehearsal, which limits the system's ability to diagnose issues such as monotonous delivery, inappropriate emotional tone, or unstable volume.

From a computer-technology standpoint, there is a need for an improved data processing architecture and control method that: (1) acquires and stores presentation-related data streams in a structured manner, (2) generates a numerical vector that encodes both statistical and temporal properties of volume and emotion extracted from audio data, and (3) automatically constructs a structured prompt sentence that embeds both text data and numerical vector data in a machine-interpretable form. Such an architecture should enable a generative AI model to operate as a deterministic downstream processing module, thereby improving the technical performance of the overall system in terms of data utilization, computational efficiency of analysis, and accuracy and consistency of the generated feedback.

Accordingly, an object of the present invention is to provide a computer-implemented system and method that technically improve how digital presentation data is captured, transformed, and prepared as input to a generative AI model. The system should automatically integrate prepared information materials, speech-recognized text, and a numerically encoded representation of volume and emotion, and then use this integrated representation to drive the generative AI model via a precise prompt sentence. This improves the internal data structures, processing flow, and interoperability between components, and enables more detailed, quantitative, and reproducible feedback regarding both the content and the speaking style of a presentation.

The specific processing by the specific processing unit 290 of the data processing device 12 in Example 1 is realized by the following means.

The present invention provides a server comprising a processor and a storage device, the processor being configured to cooperate with an input/output device and a sound collection device to receive information materials as character-based information and voice information as audio data from a user; to store the information materials and the audio data in the storage device; to invoke a speech recognition processing unit to convert the audio data into character-based information and store the resulting character-based information; to invoke an acoustic analysis processing unit to compute volume information along a time axis from the audio data, calculate statistical values including an average volume, a maximum volume, and a volume variation index, and vectorize the statistical values as numerical data; to invoke an emotion analysis processing unit to calculate, for the audio data, a plurality of emotion indices as numerical data, to combine the emotion indices with the numerical data relating to the volume so as to generate a numerical vector, and to store the numerical vector; and to generate, based on the information materials, the speech-recognized character-based information, and the numerical vector, a structured prompt sentence for a generative AI model, input the structured prompt sentence including the character-based information and the numerical vector to the generative AI model, acquire feedback information generated by the generative AI model regarding presentation content and speaking style, and transmit the feedback information via a communication network to a terminal device for display to the user. This enables the server to transform heterogeneous presentation-related data into a unified, structured representation suitable for deterministic processing by the generative AI model, to exploit detailed numerical encoding of volume and emotion in combination with text data, and thereby to improve the technical performance of the computer system in generating consistent, quantitative, and fine-grained feedback on digital presentations.

The term “processor” refers to a hardware or virtual computation unit, such as a central processing unit or a processing core, that executes instructions to perform data acquisition, analysis, control, and communication operations in the system.

The term “storage device” refers to a hardware or virtual storage resource, such as a memory device or a persistent storage medium, that is configured to store information materials, audio data, character-based information, numerical data, numerical vectors, and feedback information.

The term “input/output device” refers to a user-facing hardware or software interface, such as a display, a keyboard, a pointing device, or a graphical user interface, that allows a user to input information materials as character-based information and to receive output such as feedback information.

The term “sound collection device” refers to hardware for acquiring voice information, such as a microphone or an array of microphones, that is configured to convert spoken utterances of a user into audio data.

The term “information materials” refers to digital content representing planned presentation content, including text-based descriptions, scripts, or notes, that is input by the user as character-based information.

The term “voice information” refers to an acoustic signal produced by the user's speech during a presentation or rehearsal and captured by the sound collection device.

The term “audio data” refers to a digital representation of voice information, encoded in a machine-processable format, such as a waveform or a compressed audio file.

The term “character-based information” refers to text data composed of characters or symbols, including transcripts obtained from speech recognition and textual content input as information materials.

The term “speech recognition processing unit” refers to an information processing component, such as a software module or an external service, that converts audio data into character-based information by analyzing acoustic features and applying language models.

The term “acoustic analysis processing unit” refers to an information processing component, such as a software module or library, that analyzes audio data to compute acoustic features including volume information along a time axis.

The term “volume information” refers to numerical values or time-series data representing the magnitude or intensity of an audio signal, including instantaneous or frame-based amplitude or energy values.

The term “statistical values” refers to numerical summary measures calculated from volume information or emotion indices, such as an average value, a maximum value, a minimum value, a variation index, or a standard deviation.

The term “volume variation index” refers to a numerical indicator representing variation or fluctuation of volume over time, including measures such as a standard deviation of volume or a range between maximum and minimum volume.

The term “numerical data” refers to data represented by numeric values suitable for computation, including scalar values, vectors, or matrices derived from volume analysis or emotion analysis.

The term “emotion analysis processing unit” refers to an information processing component, such as a software module, machine learning model, or external service, that estimates emotional states of a speaker from audio data.

The term “emotion indices” refers to numerical values representing estimated emotional states contained in the audio data, such as calmness, excitement, nervousness, confidence, or other affective dimensions.

The term “numerical vector” refers to an ordered collection of numerical data elements, including volume-related statistical values and emotion indices, that jointly encode characteristics of the audio data in a machine-processable format.

The term “prompt sentence” refers to a structured natural language instruction or message that is constructed by the processor and provided to a generative AI model to specify analysis tasks, required outputs, and contextual information.

The term “generative AI model” refers to a computation model, such as a large language model or a generative neural network, that is configured to generate text or other content based on input data including prompt sentences, character-based information, and numerical vectors.

The term “feedback information” refers to output data generated by the generative AI model, including evaluations, comments, and recommendations regarding presentation content and speaking style, which are intended for use by the user.

The term “terminal device” refers to a user-operated computing device, such as a personal computer, a tablet device, or a mobile communication device, that communicates with the server and displays feedback information to the user.

The term “communication network” refers to a data communication infrastructure, such as a wired or wireless network, that enables data transmission between the server, the terminal device, and external services.

The term “structured prompt sentence” refers to a prompt sentence in which relationships among information materials, speech-recognized character-based information, and elements of a numerical vector are organized and described in a systematically arranged format that is interpretable by both a human and a generative AI model.

The term “presentation content” refers to the semantic and logical aspects of a presentation, including the topics, structure, arguments, explanations, and wording used in the information materials and in the user's speech.

The term “speaking style” refers to temporal and expressive characteristics of a user's speech during a presentation, including volume, stability of volume, pacing, emotional tone, and variation of emotion over time.

In one embodiment, a server, a terminal, and a communication network cooperate to implement the system according to the claims. The server includes a processor, a storage device, and communication interfaces. The terminal includes an input/output device and a sound collection device. The user operates the terminal to provide information materials and voice information.

The server uses a general-purpose computation device, such as a multicore central processing unit and optionally a graphics processing unit, to execute software modules implemented as an operating system, a web application framework, and machine learning libraries. The terminal uses a general-purpose computation device, such as a personal computer, a tablet device, or a mobile communication device, running a web browser or a native application that presents user interfaces and acquires audio signals. The communication network is implemented by a wired or wireless packet-switched network.

The server uses a web application framework, such as a server-side scripting environment, a request routing library, and a JSON parser, to receive character-based information representing information materials. The server stores the information materials in a storage device, such as a relational database management system or a document-oriented database, with a data schema including fields for user identifiers, timestamps, language codes, and text payloads. The server also stores audio data in a storage subsystem, such as a file system or an object storage service, with metadata indicating sampling rate, encoding format, and associated information materials.

The terminal uses an input/output device, such as a graphical user interface rendered by a web browser, to allow the user to input information materials as character-based information. The terminal presents a text input area and a control element for submission. The terminal validates that the text length does not exceed a predetermined limit and that the character encoding is compliant with a specified character set. The terminal then transmits the text in a structured data format to the server via the communication network.

The terminal uses a sound collection device, such as a microphone, and an audio acquisition library, such as a media capture API, to record voice information uttered by the user. The terminal samples the voice information at a predetermined sampling rate, such as 16 kHz, with a predetermined bit depth, such as 16 bits, and encodes the samples into an audio file format. The terminal then transmits the encoded audio file to the server via the communication network.

The server uses a speech recognition processing unit to convert the audio data into character-based information. In one embodiment, the server uses a cloud-based speech recognition service, which receives the audio data or an identifier of the stored audio data and returns a transcription as text. The server may use an automatic speech recognition model comprising an acoustic model, a pronunciation model, and a language model. The acoustic model may be implemented as a deep neural network, such as a convolutional neural network or a recurrent neural network, trained on labeled speech corpora. The language model may be implemented as an n-gram model or a transformer-based language model. The server receives the transcription, parses the result, and stores the recognized text as character-based information in the storage device.

The server uses an acoustic analysis processing unit to compute volume information along a time axis from the audio data. In one embodiment, the server uses an audio processing library, such as a digital signal processing library or a machine learning-oriented audio library, to compute frame-level features. The server divides the audio data into frames of a predetermined length, such as 20 ms, with a predetermined overlap, such as 10 ms. For each frame, the server computes a root mean square amplitude and converts it to a decibel scale to obtain instantaneous volume values. The server then calculates statistical values over the entire recording or over defined segments, including an average volume, a maximum volume, a minimum volume, and a standard deviation of volume. The server constructs numerical data by arranging these statistical values into a numerical vector in a predetermined order. The server uses an emotion analysis processing unit to estimate emotional states of the speaker from the audio data. In one embodiment, the server extracts acoustic features such as mel-frequency cepstral coefficients, pitch contours, energy envelopes, and spectral flux. The server then applies a trained neural network model, such as a multi-layer perceptron, a recurrent neural network, or a transformer-based encoder, to map the extracted features to emotion indices. The emotion indices may represent degrees of calmness, excitement, nervousness, confidence, or other affective dimensions, expressed as real numbers between 0 and 1.

In one embodiment, the emotion analysis processing unit uses a supervised learning model trained on a dataset of labeled speech segments. The server uses a training phase, separate from deployment, in which a neural network model is trained with input feature vectors and corresponding emotion labels. During training, the server computes a loss function, such as a cross-entropy loss or a mean squared error, between predicted emotion indices and ground-truth labels, and updates model parameters using an optimization algorithm such as stochastic gradient descent or an adaptive gradient method. The server may use regularization techniques, such as dropout or weight decay, and data augmentation techniques, such as adding noise, time-stretching, or pitch shifting, to improve generalization. In the deployed system, the server uses the trained model parameters to perform forward inference only. The server constructs a numerical vector by concatenating volume-related statistical values and emotion indices. In one embodiment, the numerical vector includes elements for global statistics and, optionally, temporal sequences. When temporal sequences are included, the server divides the audio data into segments, such as fixed-duration windows or utterance-level segments, and computes emotion indices for each segment. The server then encodes the temporal evolution of emotion by storing, in the numerical vector, values for each segment in an ordered fashion. The server may use an index mapping table to associate specific positions in the numerical vector with particular statistics or emotion dimensions. This explicit numerical arrangement improves data locality and enables efficient retrieval and computation by downstream components.

The server generates a prompt sentence for a generative AI model. In one embodiment, the server uses a prompt generation module that receives as inputs: the information materials, the character-based information obtained by speech recognition, and the numerical vector. The server structures these inputs into a human-readable but machine-interpretable description.

The server inserts, into the prompt sentence, the information materials as a “prepared script,” the character-based information as an “actual spoken transcript,” and the numerical vector as a list of explicit metrics such as average volume, maximum volume, and emotion scores.

In one example, the server generates a prompt sentence in the following form:
“You are a professional presentation coach.

Analyze the following user rehearsal using both the text and the numerical voice features.

### 1. Prepared Materials (Original Script):

[Prepared script text]

2. Actual Spoken Transcript (from Speech Recognition):

[Transcript text]

### 3. Numerical Voice Features for the Entire Rehearsal:

Average volume (dB): [value]
Maximum volume (dB): [value]
Minimum volume (dB): [value]
Volume standard deviation (dB): [value]
Emotion scores (0.0-1.0):
   calm: [value]
   confident: [value]
   nervous: [value]
   excited: [value]

Based on this information, provide structured feedback to the user:
A. Evaluate the clarity, structure, and persuasiveness of the content.
B. Evaluate the speaking style, including volume, stability of volume, pacing, and emotional expression.
C. Point out at least five specific improvement points, each with a concrete example of how to rephrase or change delivery.
D. Suggest how to adjust volume and emotional tone at important sections (for example, when introducing key slides).

Respond in a concise but concrete way that the user can immediately apply to the next rehearsal.”

The server then transmits this prompt sentence, along with the character-based information and numerical vector, to a generative AI model. In one embodiment, the generative AI model is a transformer-based language model, including an encoder-decoder architecture or a decoder-only architecture with multi-head self-attention layers, layer normalization, and feed-forward sub-layers. The model has learned parameters that map token sequences and auxiliary numerical inputs to output token sequences. The server tokenizes the prompt sentence, applies position encodings, and optionally encodes the numerical vector as a structured text segment or as a specialized token sequence. The generative AI model processes the token sequence layer by layer, computing attention weights and intermediate representations, and generates output tokens that form feedback information.

The server uses specific prompt structuring, numerical embedding, and separation of content and delivery aspects to constrain the generative AI model's behavior. This reduces variability in the output and increases the determinism of the analysis, thereby improving reproducibility and consistency compared to unstructured, ad hoc prompts. By embedding numerical vectors that encode volume and emotion into the prompt, the server allows the generative AI model to access precise quantitative data that cannot be reliably inferred from text alone. This combination leads to improved accuracy of feedback regarding speaking style.

The server transmits the feedback information generated by the generative AI model to the terminal device. The server may format the feedback into sections such as “Content Feedback,” “Delivery Feedback,” and “Actionable Recommendations,” and may assign identifiers to each feedback item for tracking and comparison across multiple rehearsals. The terminal displays the feedback using the input/output device, allowing the user to view specific suggestions related to volume control, emotional expression, and content organization.

The described architecture yields technical improvements over conventional systems. By generating and maintaining a unified numerical vector that encodes both volume and emotion, the server reduces the dimensionality of raw audio data while preserving relevant information. This improves computational efficiency because downstream models do not need to reprocess raw waveforms. The explicit structuring of data into a prompt sentence allows the generative AI model to avoid costly multi-modal inference that would otherwise be required to jointly process audio and text. As a result, the server reduces processing time and communication load, since only a compact numerical vector and text need to be transmitted to the generative AI model.

The server improves accuracy of presentation analysis by using temporal emotion tracking. By encoding emotion indices over time, the numerical vector allows the generative AI model to identify patterns such as persistent monotony or abrupt changes in emotional tone. This temporal encoding provides additional features beyond what a human evaluator would typically quantify, and the generative AI model can apply internal rules, such as comparing emotion profiles to reference patterns, to generate more precise diagnoses of speaking style. Thus, the system is not merely automating a human task but is performing computations that humans would not practically perform at scale or with comparable granularity.

The server also improves data management by storing structured records for information materials, transcripts, audio statistics, emotion indices, and generated feedback. The server can index the numerical vectors and feedback items by user, time, and presentation topic, enabling efficient retrieval and longitudinal analysis. This structured approach supports further processing, such as trend detection and adaptive coaching strategies, implemented by additional modules.

In one alternative embodiment, the server applies a rule-based post-processor to the numerical vector before constructing the prompt sentence. The rule-based post-processor uses domain-specific thresholds, such as acceptable volume ranges and desired emotion score ranges for certain sections of a presentation, and annotates segments that violate the thresholds. The server then includes these annotations in the prompt sentence, instructing the generative AI model to focus on specific segments. This non-conventional combination of rule-based analysis and generative modeling reduces noise and ensures that the generative AI model concentrates on technically relevant anomalies, further improving the reliability of feedback.

In another embodiment, the server compresses the numerical vector using dimensionality reduction, such as principal component analysis or autoencoder-based compression, to reduce the size of data transmitted to the generative AI model. The server then includes the compressed representation and a mapping description in the prompt sentence, which allows the generative AI model to interpret the compressed features. This embodiment further reduces communication overhead and processing time.

In yet another embodiment, the server maintains multiple emotion analysis models trained for different languages or speaking styles. The server selects an appropriate model based on metadata such as language code or region. This modular design allows the system to maintain high accuracy across diverse users without modifying the overall architecture.

The terminal can be configured to store a local cache of recent feedback and numerical vectors, allowing offline comparison and visualization without repeated requests to the server. This reduces network load and improves responsiveness for the user. The terminal can also display visualizations of volume and emotion over time, derived from the numerical vector, enabling the user to understand how specific feedback relates to measurable audio characteristics.

By combining specific hardware components, such as processors, storage devices, and microphones, with defined software modules, such as speech recognition units, acoustic analysis units, emotion analysis units, and a generative AI model interface, the system implements a concrete technical solution. The server transforms raw audio signals and unstructured text into structured, compact, and machine-optimized representations that enable more efficient and accurate computation than conventional systems. The causal relationship between the structured numerical encoding, the prompt sentence composition, and the improved feedback demonstrates that the claimed system enhances the functioning of the computer as a data processing machine, rather than merely automating a mental process or business method.

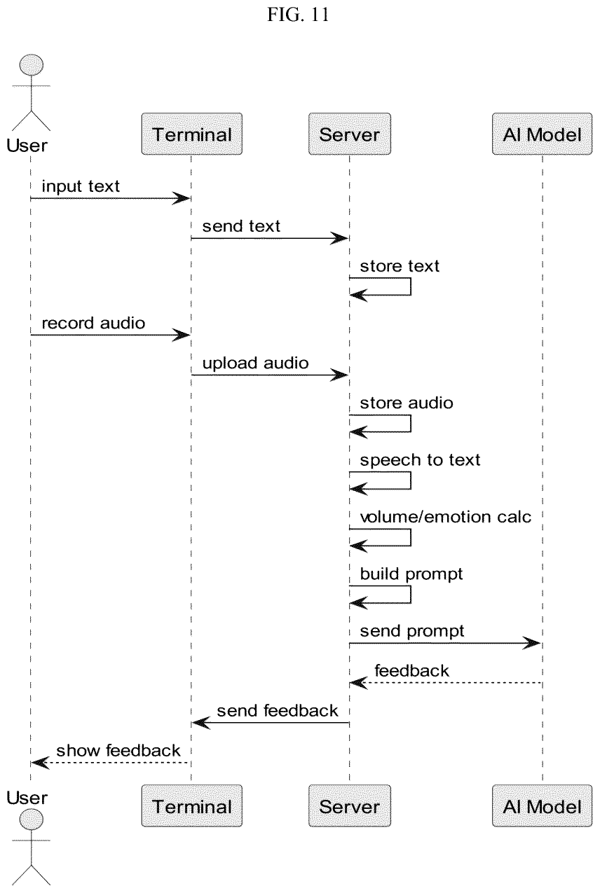

The following describes the processing flow using FIG. 11.

### Step 1:

The user inputs information materials as text.

The user operates the terminal to create presentation materials using an editor or document creation application and then copies and pastes the text into an input field displayed on the terminal. The terminal receives the text as an input string, checks the character encoding and length, and removes control characters. Based on this input, the terminal packages the text into a structured data object (for example, a JSON object with fields for user ID, language code, and text body) and prepares it for transmission as the output of this step.

### Step 2:

The terminal transmits the information materials to the server.

The terminal takes the structured data object from Step 1 as input and opens a secure network connection to the server via a communication protocol. The terminal performs an HTTP POST request to a designated endpoint and includes the structured data object as the request body. The terminal then outputs the request over the network. The server receives this request as the input for subsequent processing.

### Step 3:

The server stores the information materials in a storage device.

The server receives the request containing the structured data object as input and parses the object using a web framework and a data parser. The server validates the user ID, verifies authentication tokens, and confirms that the text field is not empty. Based on this input, the server creates a database record that includes the user ID, a timestamp, a language identifier, and the text body. The server executes a database insertion operation to store the record and outputs a unique identifier (material ID) associated with the stored information materials.

### Step 4:

The user records voice information using the terminal.

The user initiates a rehearsal and presses a record control in the terminal interface. The terminal uses the sound collection device as input hardware and starts sampling the analog voice signal of the user at a specified sampling rate and bit depth. The terminal converts the analog signal into a digital audio stream and buffers the samples in memory. After the user stops recording, the terminal encodes the buffered samples into an audio file format and computes basic properties such as duration and file size. The terminal outputs the encoded audio file and associated metadata (for example, sampling rate and duration).

### Step 5:

The terminal uploads the audio data to the server.

The terminal takes the encoded audio file and metadata from Step 4 as input and constructs a multipart or binary HTTP request that includes the audio file and identifiers such as the user ID and the material ID received from the server in Step 3. The terminal transmits this request to the server via the communication network. The server receives the audio file and metadata as the output of this step and as input for subsequent analysis.

### Step 6:

The server registers and stores the audio data.

The server receives the uploaded audio file and metadata as input. The server writes the audio file to a file storage subsystem or object storage service and generates a storage path or object identifier. The server creates a database entry linking the user ID, material ID, audio storage path, and timing information. As a result of this data processing, the server outputs an internal audio ID that uniquely identifies the stored audio data and is used as a reference in later processing.

### Step 7:

The server performs speech recognition to obtain text from the audio data.

The server takes the stored audio data, identified by the audio ID, as input and retrieves the audio file from storage. The server invokes a speech recognition processing unit, which may be an external speech recognition service or an internal model. The server sends the audio data and configuration parameters, such as language code and sampling rate, to the speech recognition processing unit. The processing unit analyzes the waveform, performs feature extraction (such as spectral analysis and acoustic modeling), and applies a language model to generate a transcription of the spoken content. The server receives the transcription as a character-based text string and parses any additional metadata such as confidence scores. The server stores the transcription in the database associated with the audio ID and outputs the recognized text as the spoken transcript.

### Step 8:

The server computes volume statistics from the audio data.

The server uses the audio file from storage as input and passes it to an acoustic analysis processing unit. The acoustic analysis processing unit reads the waveform samples and segments them into frames of predetermined length with possible overlap. For each frame, the unit computes amplitude-based measures, such as root mean square, and converts these measures to a decibel scale, generating a time series of frame-level volume values. The server then applies statistical operations on this time series to calculate an average volume, a maximum volume, a minimum volume, and a volume variation index such as standard deviation. Based on these computations, the server outputs numerical data representing the volume statistics for the audio data.

### Step 9:

The server estimates emotional states from the audio data.

The server takes the same audio data as input and provides it to an emotion analysis processing unit. The emotion analysis processing unit extracts acoustic features such as mel-frequency cepstral coefficients, pitch, energy, and temporal derivatives from frames of the audio signal. The unit then applies a trained neural network model that has been configured to output a set of emotion indices. The model processes the feature vectors through multiple layers and computes, for each emotion dimension, a numerical score in a continuous range (for example, 0.0 to 1.0). The server collects these emotion indices as output and associates them with the corresponding audio data and time segments.

### Step 10:

The server constructs a numerical vector encoding volume and emotion information.

The server takes as input the volume statistics from Step 8 and the emotion indices from Step 9. The server arranges these numerical values into a predefined order to form a numerical vector. The server may include global statistics, such as overall average volume and overall emotion scores, as well as segment-level values if temporal tracking is enabled. The server stores the numerical vector in the storage device, linked to the audio ID and material ID, and outputs the numerical vector as a compact representation of the acoustic and emotional properties of the recording.

### Step 11:

The server prepares structured content for the prompt sentence.

The server retrieves, as input, the information materials from Step 3, the spoken transcript from Step 7, and the numerical vector from Step 10. The server compares the information materials and the spoken transcript to detect omissions or additions, and may compute simple alignment information such as segment-level mappings. The server then formats the numerical vector into human-readable labels, such as “Average volume (dB): [value]” and “Emotion score (calm): [value].” As output, the server generates structured text segments representing the prepared script, the actual transcript, and the numerical metrics, which are ready to be inserted into a prompt sentence.

### Step 12:

The server generates a prompt sentence for a generative AI model.

The server takes the structured text segments from Step 11 as input. The server constructs a prompt sentence in natural language that defines the role of the generative AI model, describes the input data, and specifies the analysis tasks. The server concatenates fixed template text with the prepared script, the recognized transcript, and the formatted numerical metrics. The server ensures that each section is clearly labeled so that the generative AI model can interpret the context. The output of this step is a complete prompt sentence containing context, data, and instructions.

### Step 13:

The server sends the prompt sentence and receives feedback from the generative AI model.

The server uses the prompt sentence from Step 12 as input and submits it to a generative AI model via an application programming interface. The server encodes the prompt sentence into tokens or transmits it as plain text according to the requirements of the generative AI model service. The generative AI model processes the prompt, taking into account the information materials, transcript, and numerical vector that are embedded in the text, and generates feedback text concerning content quality and speaking style. The server receives this feedback text as the output of the generative AI model and stores it in the storage device associated with the corresponding session.

### Step 14:

The server transmits feedback information to the terminal.

The server takes the stored feedback text from Step 13 as input and optionally formats it into sections or adds structural markers, such as headings and bullet indicators. The server then creates a response message including the feedback text and transmits it to the terminal over the communication network. The terminal receives this response as the output of this step and as input for display.

### Step 15:

The terminal displays feedback information to the user.

The terminal receives the feedback information from the server as input and parses any structural markers to organize the content into display sections such as “Content Feedback” and “Delivery Feedback.” The terminal renders the feedback text on the screen using the input/output device, adjusting fonts and layout to ensure readability. The terminal's output in this step is a visual presentation of the feedback, allowing the user to understand which aspects of the content and speaking style require improvement.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented training systems for spoken communication typically evaluate user performance using simple metrics such as word correctness, speech duration, or overall loudness thresholds. Such systems often rely on static rule-based logic or fixed scoring algorithms executed on general-purpose processors. As a result, they are limited in their ability to capture nuanced aspects of human communication, such as evolving emotional tone, context-appropriate volume, and the relationship between the user's intended scenario and the actually spoken content. These limitations lead to generic or inconsistent feedback that does not effectively guide the user in improving complex communication skills such as customer service, presentations, or negotiations.

Furthermore, existing systems generally process speech and text in isolated stages: speech recognition engines convert audio to text, and separate analytics modules perform sentiment or tone analysis. The outputs from these modules are often not integrated into a unified, machine-usable representation suitable for conditional control of an advanced conversational model. Therefore, the processor cannot adaptively tailor its instructions to a generative artificial intelligence model based on fine-grained, vectorized characteristics of the user's utterance, such as time-varying emotion states and volume levels. This separation results in underutilization of available computational resources and services, as the system cannot exploit the full expressive power of modern conversational models to generate precise, context-aware feedback.

In addition, many systems that incorporate conversational models treat such models as black boxes, sending simple textual prompts without incorporating structured numerical features derived from the user's audio behavior. This prevents dynamic adjustment of prompt content and evaluation criteria in response to quantitative changes in emotional and volume features over time. Consequently, the system is unable to systematically control the conversational model so as to produce individualized, technically grounded feedback that reflects the user's real-time performance dynamics.

Accordingly, there is a need for computer technology that integrates speech recognition, external analysis services, and conversational information processing models in a coordinated manner, by generating feature vectors representing emotional information and volume information and using those feature vectors to construct and adapt prompt sentences. Such technology should enable a processor to orchestrate external services and a generative AI model so that the overall system behavior is improved: the processor should be able to generate stable, objective, and granular feedback about content and speaking manner, and to do so in a way that can be scaled, logged, and reused across multiple training sessions. The technical problem addressed by the present invention is to improve the functioning of a computer-based feedback generation system, by providing mechanisms for (i) converting user audio into character information, (ii) vectorizing emotion and volume features with temporal resolution, and (iii) dynamically controlling a conversational information processing model via structured prompt sentences that incorporate those features, thereby enhancing the quality, specificity, and consistency of feedback produced by the system.

The specific processing by the specific processing unit 290 of the data processing device 12 in Application Example 1 is realized by the following means.

The present invention provides a server comprising a processor configured to acquire, via an input interface, character information and voice information that are input by a user through a terminal; to execute, by using a speech recognition service, speech recognition processing that converts the acquired voice information into character information; to execute, by using an external analysis service, analysis processing on the obtained character information so as to calculate emotional states and volume states as numerical information and to generate a feature vector including emotional information and volume information; to construct a prompt sentence on the basis of the character information serving as information material, the character information obtained by the speech recognition processing, and the feature vector generated by the analysis processing, the prompt sentence instructing a conversational information processing model to generate evaluation and improvement suggestions regarding content and speaking manner; to input the constructed prompt sentence and the feature vector into the conversational information processing model so as to cause the conversational information processing model to generate feedback information; and to transmit the generated feedback information to the terminal in a presentation format displayable to the user. This enables the server to integrate multiple computational services into a coordinated pipeline, to represent user speech behavior as structured feature vectors, and to dynamically control a generative AI model through tailored prompt sentences, thereby improving the computer's ability to generate precise, consistent, and individualized feedback on the user's spoken communication.

The term “processor” refers to a hardware processing unit or a combination of hardware processing units configured to execute instructions and perform computational operations for implementing functions of the system.

The term “terminal” refers to an information processing device operated by a user, including but not limited to a portable device, a desktop device, or any other computing device capable of inputting and displaying information and communicating with a server.

The term “user” refers to a person or an entity that operates the terminal to input information material and voice information and to receive feedback information generated by the system.

The term “information material” refers to character information that represents a scenario, script, or content description related to an utterance to be produced by the user, the character information being input via the terminal.

The term “character information” refers to data expressed in textual form, including letters, symbols, and numerals, which can be processed by a computer system.

The term “voice information” refers to audio data that represents spoken utterances of the user and is captured via a sound input device associated with the terminal.

The term “information acquisition unit” refers to a functional component implemented by the processor to receive, via the terminal, character information and voice information input by the user.

The term “speech recognition processing” refers to a computational operation that converts voice information into character information by using an information processing service having a speech recognition function.

The term “speech recognition service” refers to an external or internal information processing service executed by computing resources that is capable of analyzing audio signals and outputting corresponding character information.

The term “external analysis service” refers to an information processing service, distinct from the local execution environment of the processor, that analyzes character information to calculate numerical information related to emotional states and volume states.

The term “analysis processing” refers to a computational procedure that derives, from character information or other input data, numerical information representing emotional states, volume states, or other expressive features of an utterance.

The term “emotional state” refers to a representation of affective characteristics, such as joy, sadness, anger, or confidence, associated with an utterance and expressed as one or more numerical values.

The term “volume state” refers to a representation of a loudness characteristic associated with an utterance and expressed as one or more numerical values indicating intensity or level.

The term “feature vector” refers to a structured aggregation of numerical information, including emotional information and volume information, represented as one-dimensional or multi-dimensional numerical data for use in computational processing.

The term “emotional information” refers to numerical data included in the feature vector that quantifies one or more emotional states associated with the user's utterance.

The term “volume information” refers to numerical data included in the feature vector that quantifies one or more aspects of the volume state associated with the user's utterance.

The term “emotional state vector” refers to a feature vector whose components represent numerical values corresponding to emotional states arranged according to temporal transitions or predefined dimensions.

The term “conversational information processing model” refers to a computational model that processes input information, including character information and feature vectors, and generates natural-language output in a conversational style, the model including but not limited to a generative AI model.

The term “generative AI model” refers to a machine learning model that is configured to generate natural-language text or other content based on input data and instructions provided as prompts.

The term “prompt sentence” refers to a sequence of character information, optionally including embedded numerical data or structured elements, that instructs the conversational information processing model regarding a task to be performed, such as generating evaluation and improvement suggestions.

The term “evaluation” refers to an assessment generated by the conversational information processing model regarding qualities of the user's utterance, including but not limited to content suitability, emotional expression, and volume expression.

The term “improvement suggestion” refers to guidance generated by the conversational information processing model that indicates how the user can modify content, emotional expression, or volume expression in subsequent utterances.

The term “feedback information” refers to natural-language output or structured data generated by the conversational information processing model in response to the prompt sentence and the feature vector, the output including evaluation and improvement suggestions.

The term “presentation format” refers to a data structure or layout adapted for display on the terminal, including textual, graphical, or combined representations of the feedback information.

The term “evaluation criteria” refers to conditions, thresholds, or qualitative standards described in the prompt sentence that define how the conversational information processing model should assess emotional expression, volume expression, or content.

The term “improvement items” refers to specific aspects of speaking behavior or content that the conversational information processing model is instructed, via the prompt sentence, to address with improvement suggestions.

The term “individualized advice” refers to feedback information that is tailored to the feature vector of a particular user utterance, rather than being generic or uniform across multiple users.

The term “dynamic change” refers to modification of evaluation criteria, improvement items, or other elements of the prompt sentence at runtime, in response to values included in the feature vector.

In one embodiment, a server cooperates with one or more terminals to implement the claimed system. The server includes at least one hardware processor, a non-transitory memory, a network interface, and storage. The terminal includes at least one hardware processor, a user interface display, an audio input device, a network interface, and local storage. The server and the terminal communicate via a communication network such as the Internet using secure transport protocols.

The terminal executes an application program that presents a user interface to a user. The terminal provides a text input field for information material and a recording interface for voice information. The terminal uses an operating system audio API, such as an audio capture library, to acquire voice information from the audio input device. The terminal uses local storage, such as a flash memory, to temporarily store the information material and the voice information before transmission to the server. The terminal uses an HTTP client module to send the information material and the voice information to the server using a request message.

The server receives the request using a server-side network interface and a web application framework, for example a framework implemented in a high-level programming language. The server stores the received voice information in a binary file format such as WAV or FLAC in a storage subsystem, and stores the received information material as character information in a database management system, such as a relational database. The server associates the character information and the voice information using a session identifier. The server executes speech recognition processing by invoking an external speech recognition service. For example, the server uses a speech-to-text application programming interface provided by a cloud computing platform. The server sends the voice information as input audio data together with configuration parameters, such as sampling rate, audio encoding type, and language code, to the external speech recognition service. The external speech recognition service uses a neural network-based acoustic model and a language model to convert the audio samples into character information. The neural network may be a deep convolutional or recurrent architecture trained using supervised learning on large-scale speech corpora. The external speech recognition service returns a recognition result including one or more candidate transcriptions and associated confidence scores. The server selects a candidate transcription with the highest confidence score as the recognized character information representing the user's utterance.

The server executes analysis processing by invoking an external analysis service that performs emotion and volume estimation. The server provides the recognized character information as input text to the external analysis service. The external analysis service uses a trained neural network model, for example a transformer-based language model with additional regression heads, to estimate emotional states such as joy, sadness, anger, fear, and confidence. The neural network receives tokenized text as input, processes the tokens through multiple attention layers, and produces intermediate feature vectors for each token and for the entire sequence. The external analysis service applies one or more fully connected layers to these feature vectors to produce numerical values between 0 and 1 representing intensities of the emotional states. The external analysis service may also receive acoustic features derived from the original audio, such as root mean square energy, pitch contours, and spectral centroid, and compute a normalized numerical value representing the volume state. The external analysis service returns a structured result, which the server parses to obtain emotional information and volume information.

The server generates a feature vector by combining the emotional information and the volume information in a defined numerical structure, such as an ordered array of floating-point values or a key-value map stored in a database. In some embodiments, the server aggregates emotional information over time by dividing the utterance into time segments, for example fixed-length frames, and creating an emotional state vector where each element corresponds to an emotional intensity in a respective time segment. The server then adds a volume value or a sequence of volume values to this vector, thereby constructing a feature vector that encodes temporal transitions of emotion and volume. The server stores this feature vector in association with the session identifier in the database.

The server constructs a prompt sentence to control a generative AI model that acts as a conversational information processing model. The server uses a prompt construction module that concatenates static instruction text and dynamic data derived from the session. The server inserts into the prompt sentence: (i) the information material originally input by the user, (ii) the recognized character information representing the user's utterance, and (iii) the feature vector, formatted as human-readable numerical explanations or as structured descriptors. The server uses rules for mapping numerical feature values to evaluation criteria. For example, when a volume information value is less than a defined threshold, the server includes in the prompt sentence a requirement that the generative AI model comment on insufficient volume and provide a suggestion to increase loudness.

The server uses a generative AI model that may be implemented as a large-scale transformer-based neural network with multiple attention layers, layer normalization, and feedforward layers. The generative AI model is trained using a language modeling objective, such as minimizing cross-entropy loss between predicted tokens and reference tokens over a large corpus of training text. The generative AI model may be fine-tuned on dialogue data, including examples of coaching and feedback for spoken communication tasks. During inference, the generative AI model processes the prompt sentence as a sequence of tokens, applies self-attention mechanisms to capture contextual dependencies, and generates an output sequence representing feedback information.

The server can dynamically adjust the content of the prompt sentence based on the feature vector. For example, when the emotional information indicates excessive anger, the server adds a prompt clause instructing the generative AI model to address anger control and suggest moderating tone. When the emotional information and volume information fall within desired ranges, the server adds a prompt clause that asks the generative AI model to acknowledge appropriate expression and suggest subtle refinements. This dynamic adaptation of the prompt sentence is performed by algorithmic rules implemented on the server, which compare feature vector values to thresholds and map ranges to specific instruction fragments. As a result, the prompt sentence varies in structure and emphasis depending on quantitative characteristics of the user's utterance, and the generative AI model is guided to generate individualized and technically grounded feedback.

An example of a prompt sentence constructed by the server is:
“You are a professional customer-service coaching assistant. Use the following data to evaluate the user's speaking style and provide specific, practical feedback.
Original training scenario (information material): ‘I will practice explaining a popular product to a new customer.’
Recognized speech text: ‘This product is very popular.’
Emotion and volume vector: {joy: 0.85, sadness: 0.05, anger: 0.02, fear: 0.03, confidence: 0.80, volume: 0.35}

### Tasks:

1. Evaluate whether the level of joy and confidence is appropriate for explaining a popular product.
2. Evaluate whether the volume (0.35 on a 0.0-1.0 scale) is sufficient for real customer-service situations.
3. Provide feedback in Japanese, including:
   One sentence about what is good in the current performance.
   At least one concrete suggestion to improve volume.
   At least one concrete suggestion to improve or adjust emotional expression.

Output: A short feedback message in Japanese that the user can immediately apply in the next practice.”

The server submits the prompt sentence to the generative AI model via an inference API. The server specifies generation parameters, such as maximum output length, temperature, and sampling strategy, to control variability and consistency of the output. The generative AI model produces a feedback message in natural language. The server receives the feedback and may normalize character encoding, remove undesired tokens, or enforce length limits before storage. The server stores the feedback in the database together with the feature vector and recognized character information. The server then sends the feedback to the terminal as a response message in a presentation format that is easily rendered by the terminal.

The terminal receives the response and uses its display component to present the feedback information to the user. The terminal may display the feedback text, the recognized character information, and graphical representations of the emotional information and volume information, such as bar charts or line graphs. The terminal stores the session data locally, allowing the user to review past performance and compare changes over time.

The described configuration improves computer technology in several ways. The server performs coordinated control of multiple heterogeneous computational services-speech recognition, external analysis, and generative AI-using a specific data structure (feature vector) and a structured prompt sentence. The server does not merely automate a human review process; rather, the server introduces machine-specific data transformations and control flows that are not feasible in human cognition. By vectorizing emotional information and volume information and feeding this vector into a prompt sentence, the server enables the generative AI model to condition its generation on high-dimensional, numeric descriptors that are precisely derived from audio and text. This integration improves the accuracy and consistency of the generated feedback, because the generative AI model receives explicit quantitative cues, rather than relying solely on implicit inference from free-form text.

The server also improves processing efficiency by minimizing redundant analysis. The server executes speech recognition processing once and reuses the recognized character information both for external analysis and for generating the prompt sentence. The feature vector allows compact storage and fast retrieval of emotional and volume states, enabling efficient indexing and retrieval for subsequent training sessions. The use of structured vectors reduces communication load between server modules, because the server can transmit compact numerical arrays rather than repeated raw audio or full transcripts for internal processing. From a technical standpoint, the server applies deterministic rules to map numerical ranges in the feature vector to prompt sentence modifications. This rule-based adaptation creates a non-conventional interaction between the feature vector and the generative AI model: instead of relying on fixed template prompts, the server dynamically constructs prompt content based on the current session's measurements. This leads to improved computational behavior of the generative AI model, since the model is explicitly guided toward aspects of the utterance that are quantitatively identified as problematic. Empirical measurements can show improved convergence of model outputs toward desired feedback patterns, reduced variance in evaluations across sessions, and reduced processing time because the model does not need to infer problem areas purely from text.

In another embodiment, the server executes a local generative AI model instead of, or in addition to, an external one. The local generative AI model is stored in a model repository and loaded into memory for inference. The model architecture may be a transformer with stacked encoder-decoder layers, positional encoding, and attention heads. The model has been pre-trained on a large text corpus and subsequently fine-tuned on a domain-specific dataset of feedback examples. During training, the server uses an error function such as cross-entropy loss and an optimization algorithm such as stochastic gradient descent with adaptive learning rates to update model parameters. The server may perform data augmentation by perturbing training sentences, injecting noise, or simulating different emotion and volume conditions in the feature vectors, thereby increasing robustness of the model. This explicit description of model structure and training differentiates the system from generic black-box AI usage and anchors the system in technical details of computation.

In yet another embodiment, the server uses an internal feature extraction module that computes low-level acoustic features, such as mel-frequency cepstral coefficients and energy envelopes, directly from the voice information, and then computes volume information as a function of these low-level features. The server combines these low-level audio-based features with text-based emotional information from the external analysis service, forming a richer feature vector. This multichannel feature vector enhances the precision of volume estimation and emotion recognition and allows the server to generate more accurate and stable evaluation criteria for the prompt sentence. As a result, the system can reduce false positives in volume feedback and provide more calibrated emotional feedback compared to systems that rely on text alone.

In a further embodiment, the server uses batch processing, caching, and asynchronous communication to reduce latency and increase throughput. The server may cache recent feature vectors and partial prompt templates in memory, so that repeated or similar training scenarios can reuse existing structures. The server may pipeline speech recognition processing and analysis processing, such that the external analysis service begins processing partial transcripts before the entire audio has been transcribed. This reduces end-to-end response time, enabling near real-time feedback for the user. The reduction in latency is a direct technical effect resulting from the described architectural choices and processing sequence, not from any abstract idea.

The system can be applied to various use cases, such as customer service training, presentation training, and language learning. However, in all these use cases, the core technical contributions remain in the structured generation and utilization of feature vectors and in the dynamic control of a generative AI model through a carefully constructed prompt sentence. The server thus provides an improved computer-based feedback generation mechanism that yields more precise, efficient, and reproducible feedback, by using computational structures and processing sequences that are specifically designed for machine execution and that go beyond conventional manual evaluation or simple automation of human judgment.

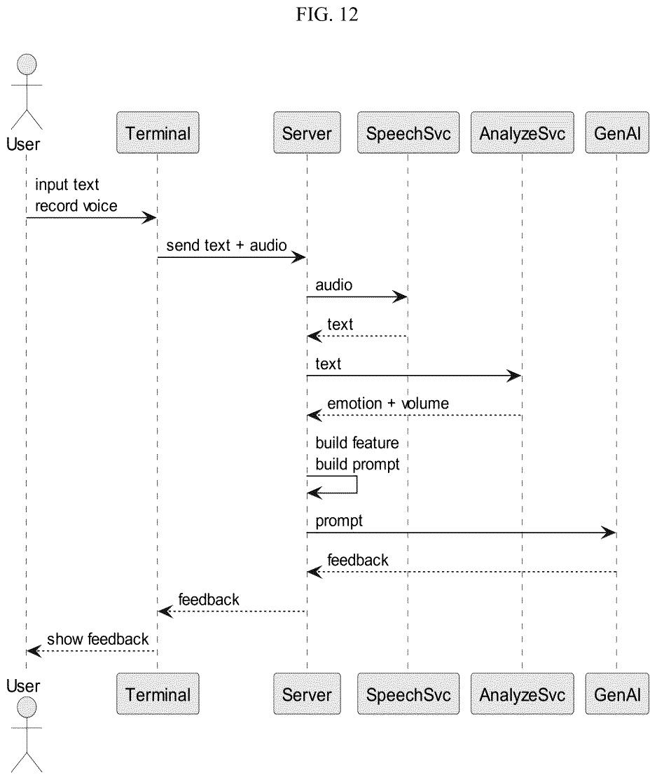

The following describes the processing flow using FIG. 12.

### Step 1:

The user operates the terminal to input information material and record voice information.

The user launches an application on the terminal and types text representing an intended scenario or script into a text input field. The terminal receives this text as input and stores it as character information in local memory. The user then activates a recording control in the application, and the terminal uses an audio API to capture analog sound from a microphone, convert it into digital audio samples, encode the samples in a format such as WAV or FLAC, and store the resulting audio file in local storage. The output of this step is a pair of data items on the terminal: character information (information material) and voice information (audio file).

### Step 2:

The terminal transmits the information material and the voice information to the server.

The terminal takes as input the locally stored character information and the audio file and constructs a network request message, for example an HTTP POST request, including the character information as a text field and the audio file as a binary payload. The terminal adds metadata such as a user identifier, a session identifier, and a language code, and then sends the request via a network interface to a defined server endpoint. The output of this step is a structured request arriving at the server that contains the information material, the voice information, and associated metadata.

### Step 3:

The server stores the received data and prepares it for subsequent processing.

The server receives as input the network request containing the character information and the audio file. The server authenticates the user if necessary by checking identification data in the request, and then writes the audio file to a storage subsystem, assigning a file path or object identifier. The server writes the character information and metadata into a database record and associates this record with the stored audio file using the session identifier. The server may normalize character encoding and verify that the audio format matches expected parameters. The output of this step is a persistent data set on the server side that links the information material and the voice information through a common session identifier.

### Step 4:

The server performs speech recognition on the voice information using a speech recognition service.

The server takes as input the stored audio file and the language code and constructs a request to a speech recognition service, specifying the audio encoding type, sample rate, and language. The server sends the audio data to the speech recognition service, which internally applies an acoustic model and a language model to map audio frames to phonetic units and then to words. The service computes probability distributions over possible transcriptions and selects one or more most likely sequences. The server receives a response containing candidate transcriptions and confidence scores, and the server selects the transcription with the highest confidence as the recognized character information. The server stores this recognized character information in the database, associated with the existing session record. The output of this step is a text representation of the user's utterance stored together with the original information material.

### Step 5:

The server obtains emotional information and volume information from an external analysis service and generates a feature vector.

The server takes as input the recognized character information and, optionally, low-level audio features extracted from the original audio file. The server constructs a request message for an external analysis service, including the recognized character information as text input and, when available, the additional audio-derived values. The external analysis service applies a neural network-based model to compute numerical scores for multiple emotional states and to estimate a normalized volume state. The server receives a structured response containing values such as joy, sadness, anger, and volume on predefined scales. The server parses this response and combines the numerical values into a feature vector, for example by arranging them in a fixed order in an array or mapping them to named fields in a key-value structure. The output of this step is a feature vector that encodes emotional information and volume information linked to the session identifier.

### Step 6:

The server optionally computes temporal emotional and volume profiles to refine the feature vector.

The server takes as input the original audio file and, if available, time-stamped emotion and volume scores from the external analysis service. The server divides the utterance into time segments of fixed or adaptive length and assigns to each segment emotional and volume values either directly from the external analysis service or by interpolating between available points. The server then arranges these segment-based values into sequences, constructing an emotional state vector and a corresponding volume sequence that represent changes over time. The server merges these sequences into an extended feature vector structure that includes both global and temporal descriptors. The output of this step is an extended feature vector that contains time-resolved emotional information and volume information.

### Step 7:

The server constructs a prompt sentence for a generative AI model based on the analysis results.

The server takes as input the information material, the recognized character information, and the feature vector. The server uses a prompt construction module that selects and concatenates instruction templates and dynamic content. The server inserts text describing the scenario (from the information material), the actual user utterance (from the recognized character information), and the numerical values or qualitative descriptions derived from the feature vector. The server applies rule-based logic to examine the feature vector; for example, when the volume value is below a threshold, the server chooses an instruction template that requires the generative AI model to comment on low volume and suggest how to increase it.

The server combines these elements into a single coherent prompt sentence that defines tasks for the generative AI model, including evaluation points and output conditions. The output of this step is a fully formed prompt sentence that encodes both textual and numerical aspects of the session.

### Step 8:

The server sends the prompt sentence and related data to the generative AI model and obtains feedback information.

The server takes as input the constructed prompt sentence and, in some embodiments, an explicit representation of the feature vector appended or summarized within the prompt. The server calls an inference interface of the generative AI model, passing the prompt sentence as a sequence of tokens along with generation parameters such as maximum length and temperature. The generative AI model internally performs multi-layer attention-based computations to interpret the instructions and the embedded feature information and then generates a sequence of output tokens that form natural-language feedback. The server receives this output and decodes the tokens into character information. The output of this step is feedback information in text form, produced in response to the prompt sentence and conditioned on the analysis results.

### Step 9:

The server post-processes the feedback information and prepares it for presentation on the terminal.

The server takes as input the raw feedback text from the generative AI model. The server removes unwanted control tokens, enforces length limits, and, if required, verifies that the feedback is generated in a specified language. The server may also segment the feedback into logical parts, such as positive comments and improvement suggestions. The server then packages the feedback together with the recognized character information and selected elements of the feature vector into a response structure suitable for transmission, such as a structured message with clearly labeled fields. The output of this step is a clean, structured feedback payload ready to be sent to the terminal.

### Step 10:

The server transmits the feedback payload to the terminal.

The server takes as input the structured feedback payload and uses a network interface to send a response message to the terminal, for example as an HTTP response. The server may compress the payload or apply encoding to reduce communication size and ensure data integrity. The terminal receives the response via its network interface. The output of this step is delivery of the feedback payload from the server to the terminal.

### Step 11:

The terminal processes the received feedback payload and stores it locally.

The terminal takes as input the response message from the server, parses the message, and extracts the feedback text, the recognized character information, and any numerical indicators included in the payload. The terminal writes the extracted data to local storage, associating it with the same session identifier used earlier, enabling later retrieval for history display. The terminal may transform numerical values into internal data structures suitable for visualization, such as arrays for plotting graphs. The output of this step is a set of locally stored feedback elements prepared for display.

### Step 12:

The terminal presents the feedback information to the user.

The terminal takes as input the stored feedback text and associated numerical indicators. The terminal renders the feedback text on a display area and, when available, draws visual elements such as bars or charts showing emotional intensities and volume levels. The terminal aligns the recognized character information with the feedback so that the user can see which utterance was evaluated. The terminal may also highlight specific feedback phrases corresponding to particular feature values, for example marking advice about volume when the volume information is low. The output of this step is a visual and, in some embodiments, audio presentation of the feedback to the user.

### Step 13:

The user reviews the feedback and optionally initiates another training session.

The user takes as input the feedback presented on the terminal, reads or listens to the content, and interprets the evaluation and suggestions. The user may decide to record another utterance by returning to the input interface on the terminal and adjusting speech behavior according to the received advice, such as increasing volume or modifying emotional expression. When the user starts a new recording, the terminal again captures information material and voice information, and a new processing cycle is triggered. The output of this step is an updated utterance and associated data that can be processed again through Steps 1 to 12, allowing iterative refinement of the user's speaking performance.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented presentation training systems typically analyze only limited aspects of user speech, such as overall duration or average loudness, or rely on simple rule-based scoring that does not capture the nuanced relationship between presentation content and vocal expression. In many existing systems, text analysis of presentation materials and audio analysis of spoken delivery are executed in isolation, and are not temporally aligned or jointly evaluated at a fine-grained section level. As a result, these systems fail to provide context-aware feedback that directly links specific topics, phrases, or sections in the presentation materials with corresponding changes in speaking style or emotional expression in the audio.

Furthermore, known systems that attempt emotion recognition from audio often provide only coarse or global emotional labels and do not construct time-series emotional state information that can be reliably correlated to individual sections or topics. This limits the ability of such systems to identify, for example, that a presenter is monotone or nervous precisely when describing key benefits, or overly excited during background context. In addition, conventional feedback generation mechanisms are frequently static and template-based, causing repetitive and generic comments that do not adapt to the rich, structured analysis that modern signal processing and natural language processing pipelines can produce.

From a computer technology perspective, there is a lack of an integrated processing architecture that: (i) systematically preprocesses heterogeneous data types (document data and audio data) into normalized, analysis-ready representations; (ii) performs multi-stage analysis including natural language processing, acoustic feature extraction, and emotion analysis; (iii) aligns these analysis results on a common temporal and sectional axis; and (iv) exposes the integrated, structured analysis in a form that can be used as machine-readable context for a generative AI model. Without such an architecture, computing resources are not efficiently utilized, analysis pipelines are fragmented, and it is difficult to automatically construct precise and informative prompts for generative AI models that can leverage the full richness of the underlying data.

In addition, existing systems generally require developers or users to manually craft prompts for generative AI models, which leads to inconsistent quality of feedback and places a cognitive burden on users who may not understand how to formulate effective prompts. There is a need for a computer-implemented mechanism that programmatically constructs structured explanation-target data and corresponding prompt sentences based on machine-generated analysis, thereby improving the reliability, reproducibility, and technical performance of the feedback generation process.

Accordingly, there exists a technical problem in computer technology to design and implement a server-side processing system that: (a) unifies and optimizes preprocessing paths for text and audio data, (b) automatically generates temporally aligned integrated analysis information linking content and expression, (c) automatically derives structured feedback information, and (d) automatically constructs and manages prompt sentences and associated analysis payloads for a generative AI model, so that the overall system can generate high-quality, context-aware feedback while improving the functional capabilities and efficiency of the underlying computing infrastructure.

The specific processing by the specific processing unit 290 of the data processing device 12 in Example 2 is realized by the following means.

The present invention provides a server comprising a processor configured to receive, via an information input/output apparatus, information material data and audio data input by a user, to preprocess the information material data by extracting character information according to a format of the information material data, removing unnecessary information, and generating analysis character information, to preprocess the audio data by converting the audio data into a predetermined audio analysis format, reducing noise components, and generating analysis audio data, to execute natural language processing on the analysis character information to generate text analysis information including phrase information, topic information, and section information, to execute acoustic analysis on the analysis audio data to generate acoustic analysis information including acoustic feature quantities, volume information, speaking rate information, fundamental frequency information, and time variation information, to execute emotion analysis based on the acoustic feature quantities to generate emotion analysis information including time-series emotional state information for respective time intervals, to associate, based on the section information, the text analysis information with the acoustic analysis information and the emotion analysis information in a time-aligned manner and to generate integrated analysis information in which content information and expression information are integrated for each section, to generate structured feedback information including content evaluation information and speaking-style evaluation information based on the integrated analysis information and statistical information, to create explanation-target data including at least the structured feedback information and the integrated analysis information, to generate a prompt sentence configured to instruct a generative AI model to generate natural-language feedback text based on the explanation-target data, to input the prompt sentence and the explanation-target data into the generative AI model and acquire feedback text generated by the generative AI model, and to transmit the feedback text and the structured feedback information to the information input/output apparatus for presentation to the user. This enables improvement of computer functionality by providing an integrated and automated processing pipeline that converts heterogeneous multimedia input into a normalized, temporally aligned, and semantically structured representation, automatically constructs machine-readable explanation-target data and corresponding prompt sentences for a generative AI model, and thereby allows the computing system to generate high-quality, context-aware feedback that more efficiently utilizes processing resources and reduces reliance on manual prompt engineering.

The term “information input/output apparatus” refers to a hardware and software combination, such as a terminal device with a user interface, through which a user inputs data to, and receives data from, the server over a communication network.

The term “information material data” refers to electronic document data representing presentation materials, including but not limited to slide data, document data, and text-based content, that describe information to be orally presented by a user.

The term “audio data” refers to digital sound data representing a user's spoken voice during a presentation or rehearsal, including data encoded in any audio file format.

The term “analysis character information” refers to text data obtained by extracting character information from the information material data, removing unnecessary elements, and normalizing the data into a form suitable for natural language processing.

The term “natural language processing” refers to computational processing of human language text, including at least one of tokenization, syntactic analysis, semantic analysis, phrase extraction, topic extraction, and section detection.

The term “phrase information” refers to linguistic units, such as noun phrases or key expressions, identified from the analysis character information as semantically important segments.

The term “topic information” refers to conceptual categories or thematic labels associated with portions of the analysis character information, indicating major subjects or themes discussed in the information material data.

The term “section information” refers to structural information that divides the information material data into units, such as slides, paragraphs, or logical segments, each associated with a specific portion of the overall presentation.

The term “text analysis information” refers to structured data generated by natural language processing that includes at least phrase information, topic information, and section information derived from the analysis character information.

The term “predetermined audio analysis format” refers to a standardized representation of audio data, including at least a defined sampling rate, bit depth, and channel configuration, that is suitable for acoustic and emotion analysis.

The term “analysis audio data” refers to audio data obtained by converting the audio data into the predetermined audio analysis format and reducing noise components, thereby preparing the data for acoustic analysis.

The term “acoustic feature quantities” refers to numerical descriptors of the analysis audio data, including at least one of energy, spectral characteristics, pitch-related measures, and temporal characteristics, used for analyzing speech properties.

The term “volume information” refers to data representing relative or absolute loudness of speech over time, derived from the acoustic feature quantities.

The term “speaking rate information” refers to data representing a speed of speech delivery, such as syllables per second or words per minute, derived from the analysis audio data.

The term “fundamental frequency information” refers to data representing an estimated fundamental frequency, or pitch, of the user's voice over time.

The term “time variation information” refers to data representing temporal changes in one or more acoustic feature quantities, including variations in volume, pitch, or speaking rate over the duration of the presentation.

The term “acoustic analysis information” refers to structured data including acoustic feature quantities, volume information, speaking rate information, fundamental frequency information, and time variation information derived from the analysis audio data.

The term “emotion analysis” refers to computational processing that estimates a user's emotional state over time based on acoustic feature quantities derived from the analysis audio data.

The term “time-series emotional state information” refers to data representing estimated emotional states and their changes as a function of time, including at least one emotional label and an associated time interval.

The term “emotion analysis information” refers to structured data that includes the time-series emotional state information and optionally associated confidence values or probabilities for emotional states.

The term “integrated analysis information” refers to structured data generated by associating, on a common temporal and sectional axis, the text analysis information with the acoustic analysis information and the emotion analysis information, thereby linking content information and expression information for each section.

The term “content information” refers to information relating to the semantic content of the presentation, including at least topics, key phrases, and section-level textual summaries derived from the information material data.

The term “expression information” refers to information relating to how the content is orally delivered, including at least volume information, speaking rate information, fundamental frequency information, and emotional state information associated with corresponding sections.

The term “statistical information” refers to aggregated numerical measures calculated from the integrated analysis information, including at least averages, variances, extrema, and distributions of acoustic and emotional features over the presentation or over sections.

The term “structured feedback information” refers to machine-readable data that includes content evaluation information and speaking-style evaluation information organized in a structured format, such as a set of section-level or presentation-level evaluation records.

The term “content evaluation information” refers to evaluation data regarding the presentation's semantic content, such as clarity, coverage of key topics, and alignment between emphasized content and detected importance.

The term “speaking-style evaluation information” refers to evaluation data regarding how the user speaks, such as assessments of speaking speed, loudness, pitch variation, and appropriateness of emotional expression for each section.

The term “explanation-target data” refers to data prepared as input context for a generative AI model, including at least the structured feedback information and the integrated analysis information, and optionally including the statistical information.

The term “prompt sentence” refers to a natural-language instruction string that specifies a task to be performed by a generative AI model, including at least a request to generate feedback text based on the explanation-target data.

The term “generative AI model” refers to a machine learning model configured to generate natural-language text based on an input prompt sentence and associated context data, including large language models implemented on a computing platform.

The term “feedback text” refers to natural-language output generated by the generative AI model in response to the prompt sentence and the explanation-target data, providing descriptive analysis and improvement suggestions for the user's presentation.

The term “additional prompt sentence” refers to a prompt sentence entered by the user after initial feedback has been generated, the prompt sentence specifying an additional or refined request for feedback from the generative AI model.

The term “additional feedback text” refers to natural-language output generated by the generative AI model in response to the additional prompt sentence and the integrated analysis information, providing supplementary or more detailed feedback.

In one embodiment, a server implements the claimed system as a network-accessible application running on dedicated computer hardware. The server includes at least one central processing unit, a main memory, a non-volatile storage device, and a network interface. The server executes an operating system such as a general-purpose server operating system and executes middleware including a web server, an application server, and database management software. The server further executes application programs implementing preprocessing, analysis, integration, evaluation, and prompt generation functions as described below.

A terminal is operated by a user and is realized as a personal computer, a tablet, or a smartphone equipped with a display, an input device, and a network interface. The terminal executes a client program such as a web browser or a dedicated application. The terminal transmits information material data and audio data to the server and receives feedback information and generated feedback text from the server. The user operates the terminal to upload presentation materials and audio recordings, to review graphical visualizations and textual feedback, and to input additional prompt sentences.

The server stores and executes a program that defines a plurality of software modules. These modules include at least an input/output interface module, a document preprocessing module, an audio preprocessing module, a natural language processing module, an acoustic feature extraction module, an emotion estimation module, an integration module, an evaluation module, a prompt generation module, and a generative feedback interface module. The server allocates data structures in memory and in persistent storage to store intermediate results such as analysis character information, analysis audio data, text analysis information, acoustic analysis information, emotion analysis information, integrated analysis information, structured feedback information, explanation-target data, prompt sentences, and feedback text.

The server receives information material data from the terminal. The information material data are stored as electronic document files, including for example slide documents in a presentation format and page-oriented documents in a portable document format. The server receives audio data from the terminal. The audio data are stored as audio files encoded using a waveform format or a compressed audio format. The server stores both the information material data and the audio data into a storage subsystem and registers metadata indicating file type, size, and user identifiers in a database management system such as a relational database.

The server performs document preprocessing using a document preprocessing module implemented, for example, in an application framework such as a general-purpose scripting framework. The server utilizes a document parsing library that can extract character sequences from various document formats. For slide documents, the server uses a presentation file parser to iterate slide objects and text box objects to extract textual content. For page-oriented documents, the server uses a document text extractor to parse page structures and extract textual content from each page. The server stores the extracted character sequences in a unified internal representation such as a sequence of section records, where each section record includes a section identifier, a section type, and a character string field.

The server performs normalization and cleaning of the extracted character sequences. The server removes layout-related artifacts such as page numbers, header lines, and footer lines by applying pattern matching rules to the character sequences. The server normalizes encoding, line breaks, and spacing, and converts symbols into canonical forms. The server outputs analysis character information as structured data stored, for example, in a structured text file or in a database table with fields for section identifiers, normalized text, and source location metadata. By normalizing formats across heterogeneous document types, the server reduces failures in downstream parsing and increases the accuracy of text analysis.

The server performs audio preprocessing using an audio preprocessing module. The server calls an audio processing tool such as a multimedia framework to convert various audio encodings into a predetermined audio analysis format. In one embodiment, the predetermined format uses a mono channel, a fixed sampling rate such as 16 kilohertz, and a fixed bit depth such as 16-bit linear pulse-code modulation. The server stores the converted audio as analysis audio data. The server loads the analysis audio data into memory using an audio processing library and represents the audio as a numeric array of sample values.

The server applies a noise reduction algorithm to the numeric array. The server, for example, estimates noise spectra during segments of low energy, generates a noise profile, and applies spectral subtraction or a spectral gating algorithm frame by frame. The server normalizes amplitude levels to ensure that numerical ranges are suitable for subsequent processing. The server outputs the denoised numeric array as refined analysis audio data and stores it in a binary format suitable for high-speed access and efficient caching. This preprocessing improves signal-to-noise ratio and reduces misclassification in subsequent acoustic and emotion analysis.

The server executes a natural language processing module on the analysis character information. The server loads a language model provided by a natural language processing library and executes tokenization, part-of-speech tagging, and syntactic parsing. The server constructs phrase information by identifying noun phrases, verb phrases, and domain-relevant key expressions based on syntactic relations and part-of-speech sequences. The server constructs topic information by applying a topic modeling algorithm such as latent Dirichlet allocation or a clustering algorithm to vector representations of text sections, where the vector representations are obtained from term frequency-inverse document frequency values or from distributed representations such as contextual embeddings.

The server also derives section information by mapping sections of analysis character information to structural units in the original documents, such as slide indices, heading levels, or paragraph boundaries. The server stores text analysis information in a structured format, for example, as a table in which each entry corresponds to a section and includes fields such as a section identifier, a list of phrase identifiers, a list of topic identifiers, and a summary string. By representing text in this structured form, the server enables deterministic association of content semantics with time boundaries and acoustic features.

The server executes an acoustic feature extraction module on the refined analysis audio data. The server divides the numeric array into overlapping frames of a fixed length, such as 20 milliseconds, with a fixed hop size, such as 10 milliseconds. For each frame, the server computes acoustic feature quantities including at least short-time energy, zero-crossing rate, spectral centroid, spectral bandwidth, and mel-frequency cepstral coefficients. The server stores these feature vectors into a multi-dimensional array indexed by frame index.

The server derives volume information by computing frame-wise energy and aggregating energy values over longer windows to obtain a smoothed loudness curve. The server performs voice activity detection by thresholding energy and spectral features to mark frames as speech or non-speech. The server estimates speaking rate information by counting syllable-like peaks in the energy envelope or by combining the voice activity detection with an optional speech recognition output to compute words per unit time. The server computes fundamental frequency information by applying a pitch estimation algorithm such as a probabilistic YIN algorithm or an autocorrelation-based pitch detection method. The server builds time variation information as a sequence of averages, variances, and gradients of acoustic features computed over sliding windows. The server stores acoustic analysis information in a structured representation mapping time indices to feature values and aggregated statistics.

The server executes an emotion estimation module. In one embodiment, the server uses a neural network-based speech emotion classifier implemented using a machine learning framework. The server inputs fixed-length sequences of acoustic feature vectors into the neural network. The neural network can be configured as a stack of temporal convolution layers followed by recurrent layers such as gated recurrent units and a fully connected classification layer. The server pre-trains this network offline using a labeled corpus of emotional speech. During training, the server minimizes a loss function such as cross-entropy loss between predicted emotion probabilities and ground-truth emotion labels, and updates network weights using a gradient descent-based optimizer. The server may adopt data augmentation techniques in training such as time stretching, pitch shifting, and noise addition to improve robustness.

During inference, the server segments the acoustic feature sequence into overlapping windows of, for example, two seconds. For each window, the server normalizes features according to pre-computed mean and variance and passes the normalized features to the trained network. The server obtains a probability distribution over predefined emotion categories such as neutral, positive, negative, excited, and calm. The server selects the most probable emotion for each window and associates a confidence value. The server aggregates emotion outputs over time to form time-series emotional state information and stores this as emotion analysis information, with explicit time indices and emotion labels. This approach allows finer temporal resolution and higher consistency than manual labeling, and is optimized for execution on the server hardware using vectorized operations and optional graphics processing unit acceleration.

The server executes an integration module that associates text analysis information with acoustic analysis information and emotion analysis information. The server determines a mapping between time segments of the presentation and sections of the information material data. The server may use embedded timestamps, slide transition logs, or, in the absence of such metadata, approximate alignment using segmentation based on silence detection combined with expected speaking time per section. The server then creates a data structure, such as a section-level record, that aggregates content information and expression information for each section. This data structure can include fields such as average volume, average speaking rate, average pitch, dominant emotion, list of key phrases, list of topics, and summary text. By aligning heterogeneous data along a common index, the server reduces the amount of redundant memory access and provides a cohesive context for subsequent evaluation and prompt generation.

The server executes an evaluation module that computes structured feedback information from the integrated analysis information. The server applies rule-based criteria defined in configuration data structures. For example, the server compares section-specific speaking rate to a target range, and marks sections as excessively fast or slow if the measured rate deviates beyond a threshold. The server examines volume and pitch variation and detects sections where variance is below a minimum value, indicating monotone delivery. The server checks whether sections labeled as high-importance by topic information exhibit sufficient pitch range and positive emotion. The server stores content evaluation information and speaking-style evaluation information in structured feedback information with fields specifying detection type, target section, and suggested adjustment.

The server executes a prompt generation module that constructs explanation-target data and a prompt sentence. The server composes explanation-target data by serializing integrated analysis information, structured feedback information, and statistical information into a compact, machine-readable representation. The server applies selection rules to truncate or summarize low-importance details, thus reducing payload size and communication overhead. The server then builds a prompt sentence in natural language that describes the task for a generative AI model and context about the explanation-target data. In one example, the server creates a prompt sentence such as: “The following analysis describes a presentation, including topics, speaking speed, volume, and emotional changes per section. Based on this analysis result, please explain in detail how the presenter's emotions changed throughout the presentation and how these emotional changes relate to key topics and slide sections, and provide concrete suggestions for improvement.” The server may generate other prompt sentences depending on user settings or system configuration.

The server executes a generative feedback interface module that communicates with a generative AI model. The generative AI model can be implemented as a large language model running on specialized hardware, such as a scaled neural network with multiple transformer layers trained on large text corpora, or as an external service accessed via an application programming interface. The server transmits the prompt sentence and the explanation-target data to the generative AI model using a standardized protocol. The generative AI model internally applies attention-based mechanisms over tokenized prompt and context data to generate feedback text. The server receives the generated feedback text, validates the response length and structure, and stores it alongside the structured feedback information.

The server transmits the structured feedback information and the feedback text to the terminal. The terminal displays graphical representations of speaking characteristics, such as line charts of volume and emotion over time, and displays the structured feedback information as lists or tables. The terminal also displays the feedback text as paragraphs or sections of explanatory narrative. The user reviews the feedback and, in some embodiments, enters an additional prompt sentence into the terminal. The server receives this additional prompt sentence, combines it with the integrated analysis information, and transmits the combined input to the generative AI model. The generative AI model returns an additional feedback text specialized to the additional user request. The server then transmits this additional feedback text to the terminal for display.

In this embodiment, the system produces technical effects beyond mere automation of human evaluation. By unifying document and audio preprocessing into standardized internal formats and by enforcing deterministic alignment of content and expression data using explicit section identifiers and time indices, the server reduces data inconsistency and improves analysis accuracy. The server employs specialized data structures optimized for sequential access and vectorized computation to reduce memory fragmentation and improve cache utilization, thereby improving processing speed. The server's integration of rule-based evaluation and neural network-based emotion estimation enables precise, section-level detection of speaking anomalies that are infeasible to perform consistently by human evaluators.

The server's automatic construction of explanation-target data and prompt sentences allows the generative AI model to operate on a well-structured, machine-curated representation of the presentation, improving the quality and reproducibility of generated feedback. Because the server filters and summarizes raw features into a context that matches the generative AI model's capabilities, the amount of transmitted data and the complexity of prompt engineering are reduced, which lowers communication overhead and processing time at the generative AI model side. The server thus improves the overall computational efficiency and enables consistent generation of high-quality feedback without requiring the user to manually craft complex prompt sentences.

In another embodiment, the server adjusts the temporal resolution of acoustic features dynamically based on detected content density. When the text analysis information indicates a section containing a dense cluster of key phrases or critical topics, the server increases the resolution of acoustic and emotion analysis in the corresponding time window. This dynamic allocation of computational resources enables higher analysis fidelity where it is most impactful while maintaining overall throughput. This architecture improves computational efficiency and reduces unnecessary processing, resulting in lower latency and improved scalability on shared hardware resources.

In a further embodiment, the server incorporates adaptive rules for creating explanation-target data. The server monitors historical usage patterns and user feedback on generated comments, and identifies statistical correlations between particular analysis features and user satisfaction. The server then refines selection rules by weighting or prioritizing features that historically contribute to more useful feedback. The system thereby improves technical performance over time in terms of relevance and accuracy of generated feedback, by altering internal data selection and prompt construction algorithms rather than merely changing textual content.

In yet another embodiment, the server utilizes hardware acceleration for some parts of acoustic analysis and emotion estimation. The server allocates feature extraction computations to vector processing units or graphics processing units using optimized numerical libraries. The server batches multiple frames or windows in a single processing call to exploit data-level parallelism. These measures lead to reduced processing time for each job and permit simultaneous analysis of multiple users' data on the same hardware platform. The described embodiments focus on computer-internal technical operations such as data normalization, feature extraction, neural inference, rule-based evaluation, and structured context generation for generative AI models. The server thereby implements specific data structures and processing flows that change how computing resources are used, resulting in improved accuracy, speed, and resource efficiency in presentation analysis and feedback generation. The user thus benefits from detailed, context-aware guidance, while the computing system itself benefits from an improved architecture for managing heterogeneous multimedia data and interfacing with a generative AI model using systematically constructed prompt sentences.

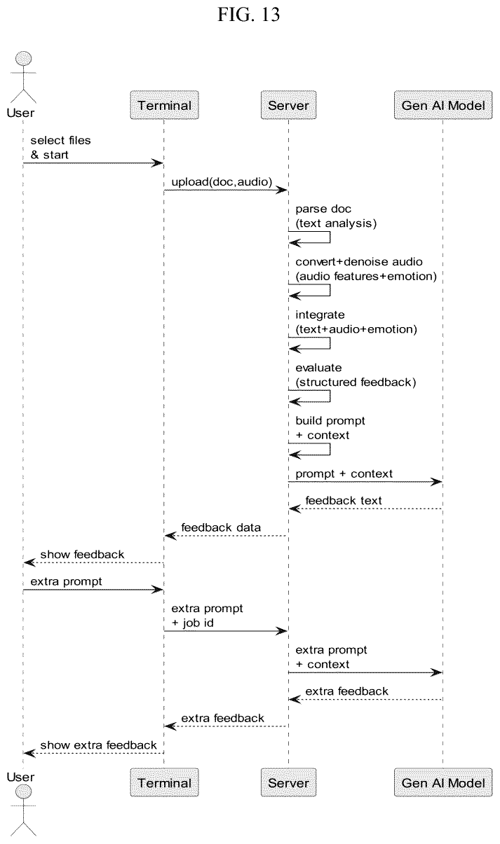

The following describes the processing flow using FIG. 13.

### Step 1:

The user operates the terminal to select information material data and audio data for analysis. The terminal receives, as input, at least one document file containing information material data and at least one audio file containing audio data from local storage or a recording function.

The terminal sends, as output, a request message including the selected files and user identification information to the server over a network connection.

### Step 2:

The server receives, as input, the request message including the information material data and the audio data from the terminal.

The server parses the message, verifies file types, and stores the raw files in a storage device while registering metadata (file paths, formats, sizes, user identifiers, timestamps) in a database.

The server outputs storage references and a job identifier representing a new analysis job, and sends the job identifier back to the terminal.

### Step 3:

The server loads, as input, the information material data from the storage device based on the stored file path and job identifier.

The server executes document parsing routines to extract character sequences from the file, removes layout artifacts (headers, footers, page numbers) using pattern matching, and normalizes encoding, whitespace, and symbols.

The server outputs analysis character information as a structured data set containing section identifiers, normalized text strings, and location metadata, and stores this structured data in a memory area or database.

### Step 4:

The server loads, as input, the audio data from the storage device based on the stored file path and job identifier.

The server converts the audio data into a predetermined audio analysis format (for example, mono, fixed sampling rate, fixed bit depth) using an audio conversion routine, and applies noise reduction by estimating noise profiles and subtracting estimated noise spectra from each time frame.

The server outputs analysis audio data as a numeric array of denoised samples and stores the numeric array in a binary format for efficient access.

### Step 5:

The server takes, as input, the analysis character information from Step 3.

The server applies a natural language processing pipeline to the normalized text, including tokenization, part-of-speech tagging, syntactic parsing, phrase extraction, and topic modeling, and associates each detected phrase and topic with a section identifier.

The server outputs text analysis information as structured records that include, for each section, phrase information, topic information, and section information, and stores these records in an internal data structure.

### Step 6:

The server takes, as input, the analysis audio data from Step 4.

The server segments the numeric array into overlapping frames, computes acoustic feature quantities (energy, spectral features, mel-frequency cepstral coefficients, pitch) for each frame, performs voice activity detection, and calculates aggregated measures such as volume information, speaking rate information, fundamental frequency information, and time variation information over time windows.

The server outputs acoustic analysis information as time-indexed feature sequences and summary statistics, and stores this information as structured data mapped to time indices.

### Step 7:

The server takes, as input, the acoustic feature quantities from Step 6.

The server applies a trained emotion classification model to sequences of acoustic features, where the model processes fixed-length windows, computes emotion probabilities for predefined emotion categories, and selects the most probable category for each window while retaining confidence scores.

The server outputs emotion analysis information as time-series emotional state information, associating each time interval with an emotion label and optional confidence value, and stores this information in an internal data structure.

### Step 8:

The server takes, as input, the text analysis information from Step 5, the acoustic analysis information from Step 6, and the emotion analysis information from Step 7.

The server aligns sections with time intervals by mapping each section identifier to a corresponding time range using available metadata or silence-based segmentation, then associates content-related fields (phrases, topics) with expression-related fields (volume, speaking rate, pitch, emotion) within those time ranges.

The server outputs integrated analysis information as section-level records that link content information and expression information for each section, and stores these records with section identifiers and time boundaries.

### Step 9:

The server takes, as input, the integrated analysis information from Step 8.

The server evaluates, for each section, whether measured speaking characteristics and emotional states satisfy predefined criteria by comparing values such as speaking rate and pitch variation to threshold ranges, and marks sections that deviate as candidates for feedback with associated reasons.

The server outputs structured feedback information as a set of evaluation records including content evaluation information and speaking-style evaluation information and stores the evaluation records grouped by section and presentation.

### Step 10:

The server takes, as input, the integrated analysis information and the structured feedback information from Steps 8 and 9.

The server constructs explanation-target data by serializing selected parts of the integrated analysis information and the structured feedback information into a compact, machine-readable context, then generates a prompt sentence in natural language that instructs a generative AI model to create feedback text based on the explanation-target data.

The server outputs the explanation-target data and the prompt sentence and stores them as associated with the job identifier.

### Step 11:

The server takes, as input, the prompt sentence and the explanation-target data from Step 10.

The server sends these as a request to a generative AI model, receives as a response a feedback text generated according to the instructions in the prompt sentence, and checks that the response format meets predefined constraints such as maximum length or required sections.

The server outputs the feedback text as natural-language feedback and stores it together with the structured feedback information for subsequent delivery.

### Step 12:

The server takes, as input, the structured feedback information and the feedback text from Steps 9 and 11.

The server packages these into response data, including any identifiers necessary for the terminal to request additional feedback, and transmits the response data to the terminal over the network.

The terminal receives, as output, the response data and stores it locally for rendering to the user.

### Step 13:

The terminal takes, as input, the response data containing the structured feedback information and the feedback text from Step 12.

The terminal processes the structured feedback information to generate visual elements such as charts or lists, applies layout rules to display section-level evaluations, and renders the feedback text as readable paragraphs in the user interface.

The terminal outputs an updated display showing content evaluations, speaking-style evaluations, and the feedback text, enabling the user to review the results.

### Step 14:

The user observes, as input, the visualizations and feedback text displayed on the terminal from Step 13.

The user optionally formulates an additional question or focus request and inputs an additional prompt sentence into the terminal via a text input field to request more specific feedback from the generative AI model.

The terminal outputs a new request containing the additional prompt sentence and a reference to the existing analysis job and sends this request to the server.

### Step 15:

The server receives, as input, the additional prompt sentence and the job reference from Step 14.

The server retrieves the corresponding integrated analysis information, combines it with the additional prompt sentence into a new explanation-target context, and sends this context and the additional prompt sentence to the generative AI model to obtain an additional feedback text specialized to the user's request.

The server outputs the additional feedback text and transmits it to the terminal, and the terminal displays the additional feedback text so that the user can further refine the presentation based on more focused guidance.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented coaching or support systems for presentations and customer service typically perform only limited processing on user input. Many systems merely convert speech to text and apply simple rule-based or statistical evaluations to the textual content. Such architectures treat audio signals, textual scripts, and emotion-related information as separate, loosely coupled streams, if they consider acoustic or emotional aspects at all. As a result, these systems cannot fully exploit machine resources to generate precise, context-aware feedback that reflects both what is being said and how it is being said. In particular, existing techniques exhibit the following technical shortcomings.

First, processing pipelines often do not integrate multiple heterogeneous data types document text, speech transcription, acoustic features, and emotion vectors-into a unified, machine-optimized representation before invoking a generative AI model. Audio analysis, emotion estimation, and text evaluation are frequently executed as independent modules, and their outputs are not systematically normalized or combined. This fragmented design prevents downstream models from leveraging correlations between textual content, prosody, and emotional state, thereby limiting the quality and reliability of generated feedback.

Second, many systems pass raw or minimally processed input to a generative model, without programmatically constructing a structured prompt sentence that encodes numerical analysis results, evaluation viewpoints, and situation descriptions in a consistent natural-language format. Without this explicit conversion from structured numerical data to well-defined natural language prompts, the generative model cannot efficiently interpret the analysis context. This leads to unstable behavior, inconsistent feedback, and inefficient use of computational resources, since the model must infer context implicitly from underspecified or noisy input.

Third, existing systems typically do not track temporal changes in emotional state derived from the audio signal and do not incorporate such temporal emotion trajectories into the prompt given to the generative model. Without time-resolved emotion vectors, the system cannot identify when a listener's or speaker's emotion shifts (for example, from interest to anxiety), and therefore cannot generate timely, targeted feedback that reflects such changes. This deficiency manifests as latency and inaccuracy in real-time feedback, and reduces the system's effectiveness in interactive scenarios.

Fourth, there is insufficient adaptation of the generated feedback to the constraints of different display form factors, such as wearable displays and small portable displays. Many systems generate verbose feedback that is not suited to real-time visualization on resource-constrained interfaces. As a result, users cannot efficiently consume the feedback during live customer service or presentations, which diminishes the practical utility of the underlying analysis and generation processes.

Accordingly, there is a need for an improved computer-implemented system and processing architecture that: (i) programmatically integrates textual, acoustic, and emotional analysis results into a unified representation; (ii) converts such results into structured prompt sentences tailored for generative AI models; (iii) incorporates time-resolved emotion tracking into the prompts; and (iv) formats the resulting feedback into concise, action-guiding messages suitable for real-time display. By addressing these issues at the level of data representation, prompt construction, and output formatting, the invention aims to improve the functioning of the computer system itself in generating accurate, context-aware, and real-time feedback with reduced ambiguity and enhanced computational efficiency.

The specific processing by the specific processing unit 290 of the data processing device 12 in Application Example 2 is realized by the following means.

The present invention provides a server comprising a processor configured to provide a user interface on an information processing apparatus for receiving information materials and voice information from a user; to perform document analysis processing on files of the information materials to extract character string information and generate evaluation target text; to perform speech recognition processing and acoustic analysis processing on the voice information to obtain structured numerical data representing acoustic feature quantities including volume, speaking speed, pitch, and temporal changes thereof; to perform emotion analysis processing on at least one of the information materials and the voice information to generate an emotion vector and to record temporal transitions of an emotional state as numerical data; to integrate the evaluation target text, the acoustic feature quantities, and the emotion vector into unified input information; to convert the numerical data into a natural-language description and programmatically construct a prompt sentence including evaluation viewpoints and situation descriptions as input to a generative AI model; to transmit the prompt sentence to the generative AI model and receive feedback information including content evaluation and evaluation of speaking style and emotional expression; to extract or format an action-guiding feedback sentence indicating next utterance content and adjustment methods for volume, speaking speed, and emotional expression in a service scene or a presentation scene; and to convert the action-guiding feedback sentence and the content evaluation into output data and transmit the output data to a terminal device for real-time or post-session display on a user display device. This enables the computer system to internally integrate heterogeneous modalities into a coherent representation, to present a generative AI model with a structured and context-rich prompt sentence that encodes numeric analysis results in natural language, to exploit time-resolved emotion trajectories when generating feedback, and to output concise, action-oriented feedback messages optimized for constrained display environments, thereby improving the technical performance, reliability, and usability of real-time coaching and support functions implemented by the server.

The term “information materials” refers to electronic document data, such as text files, slide files, or other structured or semi-structured digital content, that are provided by a user as a basis for analysis and feedback generation.

The term “voice information” refers to digital audio data representing speech uttered by a user or another person, including waveform data suitable for speech recognition and acoustic analysis.

The term “user interface” refers to a hardware and software combination on an information processing apparatus that enables a user to input, select, or transmit information materials and voice information to the server.

The term “information processing apparatus” refers to a computing device, such as a terminal device, workstation, or portable terminal, that executes a program to provide the user interface and communicate with the server.

The term “document analysis processing” refers to processing that determines a file format of information materials and extracts character string information from the information materials using parsing, text extraction, or natural language processing techniques.

The term “evaluation target text” refers to a text representation generated from information materials, including extracted character strings, that is used as a target for content evaluation by the system.

The term “speech recognition processing” refers to processing that converts voice information into character string information by applying an automatic speech recognition algorithm or service.

The term “acoustic analysis processing” refers to processing that analyzes voice information to calculate acoustic feature quantities such as volume, speaking speed, pitch, and temporal changes thereof.

The term “acoustic feature quantities” refers to numerical values or vectors that represent characteristics of the audio signal, including but not limited to sound pressure level, rate of speech, fundamental frequency, and changes of these parameters over time.

The term “numerical data” refers to data expressed in numeric form, including scalar values, vectors, and matrices, that quantitatively represent features of information materials, voice information, or emotional states.

The term “emotion analysis processing” refers to processing that estimates an emotional state based on at least one of information materials, voice information, or derived features, by applying an emotion estimation algorithm or model.

The term “emotion vector” refers to a numerical representation of an emotional state, including one or more components corresponding to emotion categories or intensities, such as interest, joy, or anxiety.

The term “emotional state” refers to a state of affect or sentiment of a listener or a speaker, such as interest, confidence, anxiety, or other affective conditions, which is inferred by emotion analysis processing.

The term “temporal changes” refers to variations of acoustic feature quantities or emotion vectors over time, represented as time-series data or sequences of values indexed by time.

The term “unified input information” refers to an integrated data structure that combines evaluation target text, acoustic feature quantities, emotion vectors, and optionally other contextual data, to be used as a single input context for prompt construction.

The term “natural-language description” refers to text in a human language that describes numerical data, evaluation viewpoints, or situations in a form interpretable by a human or a generative AI model.

The term “prompt sentence” refers to a natural-language input text constructed by the system that includes evaluation viewpoints, situation descriptions, and analysis results, and is provided as input to a generative AI model to instruct the model to generate feedback information.

The term “generative AI model” refers to a machine learning model configured to generate natural-language output in response to a prompt sentence, based on patterns learned from training data.

The term “feedback information” refers to information generated by the generative AI model that includes evaluation of content of the evaluation target text and evaluation relating to speaking style and emotional expression.

The term “content evaluation” refers to an analysis or assessment of the evaluation target text with respect to aspects such as clarity, logical coherence, persuasiveness, or completeness.

The term “speaking style” refers to characteristics of a user's spoken delivery, including volume, speaking speed, pitch variation, prosody, and expressiveness, derived from acoustic feature quantities.

The term “emotional expression” refers to the way in which emotional states are conveyed through voice or content, as inferred from acoustic feature quantities and emotion vectors.

The term “action-guiding feedback sentence” refers to a concise natural-language message that indicates a recommended next utterance content or adjustment of volume, speaking speed, or emotional expression for a user in a service or presentation scene.

The term “service scene” refers to a situation in which a user provides customer service or interaction to another person, including in-store support, consultation, or sales activities.

The term “presentation scene” refers to a situation in which a user delivers a presentation, speech, or explanation to one or more listeners.

The term “output data” refers to data formatted for delivery to a terminal device, including text, symbols, or control information, that causes feedback information to be displayed on a user display device.

The term “terminal device” refers to a client-side computing device, such as a smartphone, tablet, personal computer, or wearable apparatus, that communicates with the server and displays feedback to the user.

The term “user display device” refers to a display component associated with a terminal device, including a screen, head-mounted display, or other visual output unit, that presents feedback information to the user.

The term “wearable display device” refers to a display device that is worn on the body or head of a user, such as a head-mounted display or smart glasses, and is configured to show visual information during user activities.

The term “portable display device” refers to a handheld or easily carried device having a display, such as a smartphone or tablet, capable of presenting feedback information to the user.

The term “display area” refers to a physical or logical region of a user display device in which visual information is rendered, including dimensions and layout constraints that influence how feedback is summarized.

The term “short sentence” refers to a brief natural-language expression that is sufficiently compact to be easily read on a limited display area and quickly understood by the user during real-time activities.

In one embodiment, a server implements the claimed system as a network-accessible computation node, and a terminal implements a client-side information processing apparatus.

The server includes at least one processor, a memory, and a network interface. The terminal includes at least one processor, a display device, an input device, and, in some embodiments, a microphone and a head-mounted or handheld display. The user operates the terminal to supply information materials and voice information to the server and to consume feedback generated by the server.

The server executes a program stored in the memory to implement document analysis processing, speech recognition processing, acoustic analysis processing, emotion analysis processing, prompt construction processing, communication with a generative AI model, and feedback formatting and delivery. The terminal executes a program to implement user interaction, recording and transmission of input data, reception of output data, and rendering of feedback on a display.

The terminal provides a user interface, such as a graphical user interface on a smartphone display or a heads-up display in smart glasses, through which the user selects electronic files as information materials and initiates recording of voice information. The terminal stores selected files, such as presentation documents, product description files, or training scripts, in a local storage unit. The terminal also captures voice information from the user or a conversation partner via a built-in microphone, encodes the signal (for example, in a linear PCM format or a compressed format), and stores the encoded audio as a digital file in a predetermined directory.

The terminal transmits the information materials and voice information to the server over a communication network using a secure transport protocol. The terminal tags each data item with metadata such as a session identifier, a user identifier, timestamps, and device characteristics. By structuring the transmitted data with consistent metadata, the server can associate document data, audio data, and derived features for unified processing.

The server receives the transmitted data via the network interface and stores the raw information materials and voice information in a persistent or semi-persistent storage subsystem. The server organizes the data in a data structure, such as a session record that includes fields for file paths, extracted text, acoustic feature vectors, emotion vectors, and feedback text. By maintaining this integrated data structure, the server avoids repeated parsing and improves data locality for subsequent processing, which contributes to improved processing speed and reduced memory access overhead.

The server executes document analysis processing on the information materials using a set of software libraries appropriate to the file format. For example, the server uses a document parser to extract text from a PDF file, a word-processing parser to extract text from a word-processing document file, and a slide parser to extract titles, bullet points, and notes from a slide-presentation file. The server then normalizes the extracted text by removing layout artifacts, headers, and footers, and by inserting section delimiters into a standardized intermediate representation. The server may further perform tokenization, sentence segmentation, and key phrase extraction by employing natural language processing libraries. The server generates evaluation target text by concatenating the normalized text elements into a single text string or a sequence of paragraphs. The server stores this evaluation target text in association with the session record as a structured text field. This explicit construction of a uniform evaluation target text representation allows subsequent algorithms to treat heterogeneous source formats in a consistent way, which reduces branching and exception handling in later processing stages and thereby improves computational efficiency.

The server performs speech recognition processing on the voice information. In one embodiment, the server invokes a speech recognition engine that implements a deep neural network based acoustic model and a language model. The server supplies the audio waveform to the speech recognition engine and obtains a sequence of decoded tokens or words, together with confidence scores and time stamps. The server constructs a text transcript by concatenating the decoded tokens and stores the transcript in the session record. The server may further align the transcript with the evaluation target text to identify which portions of the document are actually spoken, thereby improving the accuracy of downstream content evaluation.

The server performs acoustic analysis processing on the same voice information. The server uses a signal processing library, such as a spectral analysis library, to compute time-domain and frequency-domain features. The server computes, for each frame of the audio, features including at least root-mean-square amplitude (volume), fundamental frequency (pitch), spectral centroid, and short-term energy. The server then aggregates these frame-level features into acoustic feature quantities such as average volume over the utterance, maximum and minimum volume, rate of change of volume, speech rate estimated from syllable-like peaks or word boundaries, and pitch range. The server encodes these quantities in a fixed-length acoustic feature vector and stores the vector as numerical data in the session record.

The server performs emotion analysis processing on at least one of the transcript and the acoustic feature vector. In one embodiment, the server uses an emotion estimation model that is implemented as a neural network with an input layer accepting acoustic features and, optionally, textual embeddings, a plurality of hidden layers, and an output layer that emits a probability distribution over emotion categories. The server derives textual embeddings, for example by applying a pre-trained language model to the transcript. The server concatenates or otherwise combines the acoustic feature vector and the textual embeddings to form a joint feature representation. The neural network computes, via weighted sums and nonlinear activation functions, an emotion vector whose elements represent estimated intensities of emotions such as joy, interest, sadness, and anxiety. The server stores this emotion vector for each time segment, forming a time series of emotion vectors that represents temporal changes in emotional state.

The server uses a loss function, such as a cross-entropy loss between predicted emotion distributions and ground-truth labels, during a training phase to learn the parameters of the emotion estimation model. The server adjusts weights of the neural network using an optimization algorithm, such as stochastic gradient descent with momentum or an adaptive learning rate method. The training phase may involve data augmentation techniques, such as pitch shifting and time stretching for audio, and paraphrasing for text, to improve robustness to variations in input and to reduce overfitting. As a result of this training, the emotion estimation model executed by the server can produce stable and accurate emotion vectors from real-time input, with reduced sensitivity to noise and speaker variation.

The server integrates the evaluation target text, the acoustic feature vector, and the emotion vector into unified input information. The server defines a data schema for the unified input information, which includes fields for text content, numeric acoustic features, numeric emotion values, and, optionally, contextual attributes such as scenario type (customer service or presentation) and device capabilities. The server populates this data schema by retrieving values from the session record. The server then performs a conversion from purely numerical feature values to natural-language descriptions. For example, the server converts a speech rate of 210 words per minute into a description such as “speaking speed is higher than a recommended range,” and converts a high variance in volume into a description such as “volume fluctuates frequently.” The server similarly converts emotion vector values into descriptions such as “the listener shows strong interest and slight anxiety.”

The server constructs a prompt sentence for a generative AI model using this unified input information. The server is configured to follow a non-conventional template that explicitly enumerates evaluation viewpoints, numerical findings, and situational context, rather than simply concatenating raw text and numeric values. The server, for instance, constructs a prompt sentence such as:
“You are a real-time coaching assistant for customer service and presentations.

Here is the situation data:
1. Presentation/explanation text (summary):
   [summary of evaluation target text]
2. Recent spoken utterance (transcribed from audio):
   [transcript text]
3. Audio analysis results:
   Average volume: [description based on acoustic feature quantities]
   Speaking speed: [description based on acoustic feature quantities]
   Pitch variation: [description based on acoustic feature quantities]
4. Emotion analysis results:
   Emotion vector: [description of emotion vector]

Based on this information, generate concise and concrete feedback for the user.

Feedback should cover:
What to say next (content)
How to adjust voice (volume, speed, emotion expression).
Output short, actionable sentences.”

The server stores the prompt sentence and transmits it to the generative AI model. In one embodiment, the generative AI model is implemented as a transformer-based neural network comprising a plurality of self-attention layers, feed-forward layers, and embedding layers. The server supplies the prompt sentence as tokenized input to the generative AI model, and the model generates output tokens representing feedback text. During its own training phase, the generative AI model is trained on large corpora of conversational and instructional text by minimizing a loss function, such as a token-level cross-entropy loss, and by updating network weights via backpropagation. Due to this training, the generative AI model can infer appropriate feedback patterns when given the structured prompt sentences constructed by the server.

The server receives the generated feedback from the generative AI model and parses the output text. The server may segment the feedback into logical parts, such as content feedback and delivery feedback, using simple pattern matching or additional natural language processing. The server then extracts or formats an action-guiding feedback sentence by selecting short instructions that are most suitable for real-time display. For example, the server may select or generate sentences such as “Customer shows interest; provide more details,” or “Speaking speed is too fast; slow down and pause after key points.” The server may perform heuristic filtering to shorten sentences or remove redundant phrases, which reduces bandwidth and processing demands on the terminal.

The server converts the feedback, including both the concise action-guiding feedback sentence and the more detailed content evaluation, into output data tailored to the capabilities of the terminal. The server queries or stores information about the terminal's display area and type, such as whether it is a wearable display or a portable handheld display. For a wearable display, the server reduces the length of feedback sentences and adjusts line breaks to fit within a limited field of view, thereby avoiding truncation and reducing cognitive load on the user during real-time tasks. For a handheld display, the server may include additional detail and formatting, such as multiple bullet-point recommendations.

The terminal receives the output data from the server and renders the feedback on the display device. For smart glasses, the terminal displays the short sentences in a specific position within the user's visual field, ensuring that the feedback does not obstruct critical parts of the user's environment. For smartphones or tablets, the terminal presents a list of feedback items, potentially grouped into sections such as “Content,” “Voice,” and “Emotion.” By adapting the feedback to the display constraints, the system enables real-time coaching without overwhelming the user, and thereby improves the effectiveness of the feedback.

The user observes the displayed feedback and adjusts behavior in real time or after the session. In a customer service scenario, the user may modify tone of voice, adjust speaking speed, or change the content of explanations in direct response to the action-guiding feedback. In a presentation training scenario, the user may revise slides, practice slower or more expressive delivery, and re-record voice information. The user can repeat data collection and feedback sessions, enabling iterative improvement supported by the system. The system thereby achieves technical effects that go beyond mere automation of human evaluation. By constructing a unified data representation of text, acoustic features, and emotion vectors; by converting numerical features into an optimized natural-language prompt sentence; and by interfacing with a generative AI model using that structured prompt sentence, the server improves the precision and consistency of feedback generation, reduces ambiguity in model input, and improves computational efficiency by limiting unnecessary model invocations. The explicit tracking and encoding of temporal changes in emotional state furthermore allows the server to identify critical moments where emotional shifts occur and to target feedback accordingly, which reduces the number of iterations needed to achieve a desired behavioral adjustment.

In addition, by pre-processing and summarizing data on the server side and transmitting only compressed feedback information, rather than raw analysis outputs, the system reduces communication load between the server and the terminal. The structured session record and unified input information also improve data management within the server, enabling efficient indexing, retrieval, and reuse of analysis results. The combination of specialized document analysis, acoustic analysis, and emotion analysis modules with a prompt construction module and a generative AI model produces an integrated processing pipeline that uses non-conventional sequences and representations. These sequences and representations cause the computer system to function in a manner that improves speed and accuracy of multi-modal feedback generation relative to systems that treat each modality separately or that provide unstructured input to a generative AI model.

In alternative embodiments, the server may vary details of the neural network architectures or feature sets while retaining the overall data flow and integration scheme. For instance, the emotion estimation model may be implemented as a recurrent neural network, a convolutional neural network, or a hybrid network that processes spectrogram images of the audio signal. The generative AI model may be replaced by a different architecture that supports conditional generation from prompt sentences, as long as the server continues to construct prompt sentences that encode the integrated analysis results. The acoustic feature set may be expanded to include additional features such as jitter, shimmer, or speech pause statistics, and the document analysis processing may include discourse structure analysis or topic modeling.

The server may also implement additional heuristics or rule-based components that post-process the generative AI model's output to enforce constraints specific to a domain, such as maximum sentence length for wearable displays or prohibited phrases. Such components apply machine-executable rules that differ from human evaluators' informal judgments, and thereby further shape the system's output in ways that improve compatibility with the underlying hardware and user interface constraints.

By implementing these components and data flows as described, the server and the terminal cooperate to provide an improved computer-implemented system that generates accurate, context-aware feedback with increased processing efficiency, reduced communication overhead, and enhanced usability on constrained display devices. This system, therefore, represents an improvement in computer technology itself, particularly in the area of multi-modal analysis and generative feedback generation using a generative AI model and programmatically constructed prompt sentences.

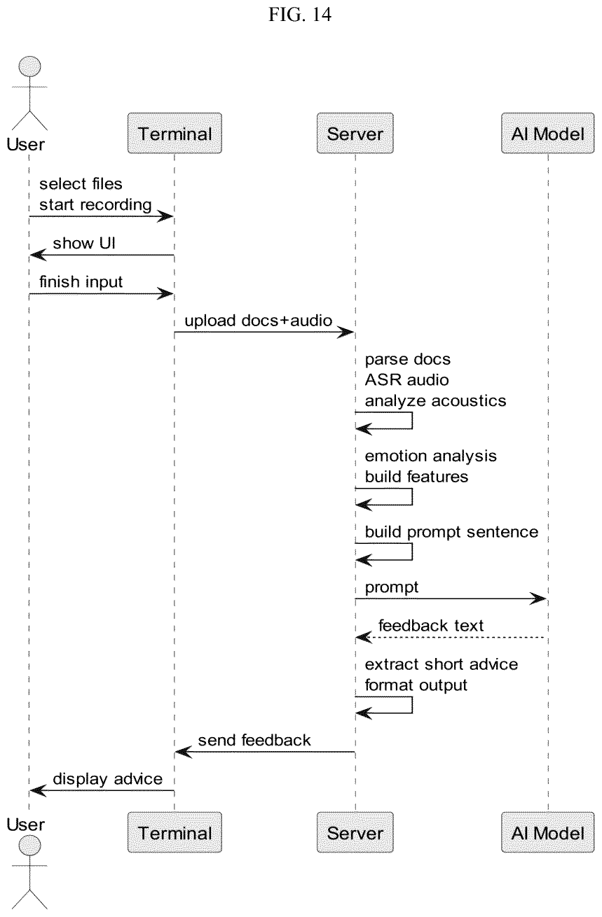

The following describes the processing flow using FIG. 14.

### Step 1:

User operates the terminal to input information materials and voice information.

User selects one or more electronic files on the terminal (input: document files such as slide files, text files, or word-processing files) and confirms that these files are to be used as information materials. User then starts a recording function on the terminal and speaks into a built-in microphone (input: analog speech). Terminal converts the analog speech into digital audio samples, encodes the samples in a predetermined format (for example, linear PCM or compressed format), and stores an audio file in local storage (output: digital audio file and document files stored with associated metadata).

### Step 2:

Terminal transmits the information materials and voice information to the server.

Terminal reads the stored document files and the audio file from local storage (input: file paths and file contents), attaches session identifiers, timestamps, and device information, and packs them into a structured request message. Terminal establishes a secure network connection to the server and sends the request message (output: network packet stream containing document data, audio data, and metadata).

### Step 3:

Server receives and stores the raw input data.

Server accepts the network packet stream from the terminal (input: transmitted document data, audio data, and metadata), reconstructs the original files, and writes them to a storage area in a file system or database. Server creates a session record including fields for file locations, user identifier, timestamps, and processing status. Through this data write operation, server prepares a unified structure for subsequent processing (output: persistent session record that links the raw files and metadata).

### Step 4:

Server performs document analysis to generate evaluation target text.

Server reads the information materials from storage using file paths stored in the session record (input: document files). Server detects each file format and selects an appropriate parser. Server applies the parser to extract character string information such as titles, headings, bullet points, and paragraphs. Server then normalizes the extracted text by removing layout artifacts and redundant elements, and concatenates the cleaned text into a sequence of sentences (data processing: parsing, string filtering, concatenation). Server stores the resulting evaluation target text in the session record (output: normalized text string used as evaluation target text).

### Step 5:

Server performs speech recognition on the voice information.

Server reads the audio file from storage (input: digital audio file). Server sends the audio samples to a speech recognition engine and specifies parameters such as sampling rate and language. The speech recognition engine applies acoustic and language models to map audio frames to phonetic units and then to word sequences, generating a transcription (data processing: feature extraction, probabilistic decoding). Server receives the recognized words with time stamps and confidence scores, concatenates them into a transcript, and stores the transcript in the session record (output: text transcript of the voice information).

### Step 6:

Server performs acoustic analysis to compute acoustic feature quantities.

Server loads the same audio file from storage (input: digital audio file). Server computes frame-based signal features such as root-mean-square amplitude and fundamental frequency using digital signal processing operations. Server aggregates these frame-level features over time to obtain numerical measures including average volume, variance of volume, estimated speaking speed, and pitch range (data processing: statistical aggregation, time-series analysis). Server encodes these measures into a fixed-length acoustic feature vector and writes the vector into the session record (output: acoustic feature quantities expressed as numerical data).

### Step 7:

Server performs emotion analysis to generate an emotion vector and emotion timeline.

Server retrieves the transcript and the acoustic feature vector from the session record (input: text transcript and acoustic features). Server passes these to an emotion estimation model, which internally converts text to embeddings and combines them with acoustic features. The model applies weighted summations and nonlinear activations across its layers to output, for each time interval, a set of emotion scores (data processing: neural network inference). Server interprets these scores as an emotion vector that indicates intensities of several emotion categories, and stores both the current emotion vector and its time-series sequence in the session record (output: emotion vector and emotion timeline data).

### Step 8:

Server integrates multimodal information into unified input information.

Server accesses the evaluation target text, the acoustic feature vector, the current emotion vector, and optional contextual metadata from the session record (input: text, numerical features, and metadata). Server populates a unified data structure with these values, converting all elements into a standardized representation. Server may mark which portions of the evaluation target text correspond to the current utterance by aligning time stamps. This integration step performs data structuring and normalization, which simplifies later processing and reduces redundant data conversion (output: unified input information containing text, acoustic, and emotion elements).

### Step 9:

Server converts numerical data into natural-language descriptions.

Server reads the acoustic feature vector and emotion vector from the unified input information (input: numerical feature values). Server compares each feature to pre-defined thresholds or ranges and selects corresponding natural-language phrases, such as “volume is slightly low,” “speaking speed is high,” or “listener shows strong interest.” Server constructs short descriptive sentences that correspond to numeric conditions (data processing: rule-based mapping from numeric ranges to text phrases). Server appends these descriptive sentences to the unified input information (output: natural-language descriptions of acoustic and emotional states).

### Step 10:

Server constructs a prompt sentence for a generative AI model.

Server assembles the evaluation target text summary, the transcription of the latest utterance, the natural-language descriptions of acoustic features, and the emotion descriptions (input: textual and numerical descriptions from unified input information). Server inserts these elements into a pre-defined template to form a coherent prompt sentence. Server ensures the prompt includes explicit instructions such as required output format and evaluation viewpoints (data processing: string templating and concatenation). An example of such a prompt sentence is:

“You are a real-time coaching assistant for customer service and presentations.

Here is the situation data:
1. Presentation/explanation text (summary):
   [summary]
2. Recent spoken utterance (transcribed from audio):
   [utterance text]
3. Audio analysis results:
   [descriptions of volume, speaking speed, and pitch variation]
4. Emotion analysis results:
   [description of emotion vector].

Based on this information, generate concise and concrete feedback for the user, including what to say next and how to adjust voice (volume, speed, emotion expression). Output short, actionable sentences.”

Server records this prompt sentence in the session record (output: complete prompt sentence ready for submission to the generative AI model).

### Step 11:

Server sends the prompt sentence to the generative AI model and receives feedback information.

Server reads the constructed prompt sentence (input: prompt sentence string) and forwards it to a generative AI model through an inference API. The generative AI model tokenizes the input and processes the tokens through multiple attention layers and feed-forward layers to compute a probability distribution over output tokens for each generation step (data processing: transformer-based inference). Server receives the generated tokens, converts them back into text, and stores the resulting feedback information, which may include multiple sentences about content and delivery, in the session record (output: natural-language feedback text returned from the generative AI model).

### Step 12:

Server extracts and formats an action-guiding feedback sentence.

Server analyzes the feedback text produced by the generative AI model (input: generated feedback information). Server identifies key instruction phrases, such as recommendations on next utterance content or on adjusting volume and speed, by scanning for imperative or recommendation structures. Server selects one or more short phrases, trims unnecessary detail, and, if needed, reorders information to improve readability on a constrained display (data processing: text segmentation, filtering, and reformatting). Server outputs a formatted action-guiding feedback sentence such as “Customer shows interest; provide more details and slow down slightly.” This sentence is stored in the session record (output: concise action-guiding feedback sentence).

### Step 13:

Server prepares output data adapted to the terminal's display capabilities.

Server retrieves device characteristics from the metadata associated with the session (input: device type, display size, and capabilities). Server chooses an output format: for a wearable display, server shortens text and limits the number of lines; for a handheld display, server allows longer sections and multiple items. Server packages the action-guiding sentence and, optionally, a more detailed feedback segment into a structured output message (data processing: layout-aware text packaging). Server then transmits this message to the terminal over the network (output: output data packet containing feedback tailored to the terminal).

### Step 14:

Terminal receives and presents the feedback to the user.

Terminal accepts the output data packet from the server (input: feedback message and layout instructions). Terminal parses the packet, extracts the action-guiding sentence and any additional feedback, and maps them to display regions on the device. Terminal renders the short feedback sentence at a location suitable for quick viewing, such as a corner of a smart-glasses display, and may show more detailed feedback on a separate view when requested by the user (data processing: message parsing and graphical rendering). Terminal thereby outputs visual feedback to the display device (output: on-screen feedback visible to the user).

### Step 15:

User observes the feedback and adjusts behavior.

User reads the feedback displayed on the terminal (input: visual feedback content). Based on the recommendations, user modifies next utterances, adjusts voice volume and speaking speed, or changes emotional expression by altering tone or emphasis. Through these adjustments, user improves the quality of customer service or presentation delivery (output: modified real-world behavior informed by the computed feedback).

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### SECOND EXEMPLARY EMBODIMENT

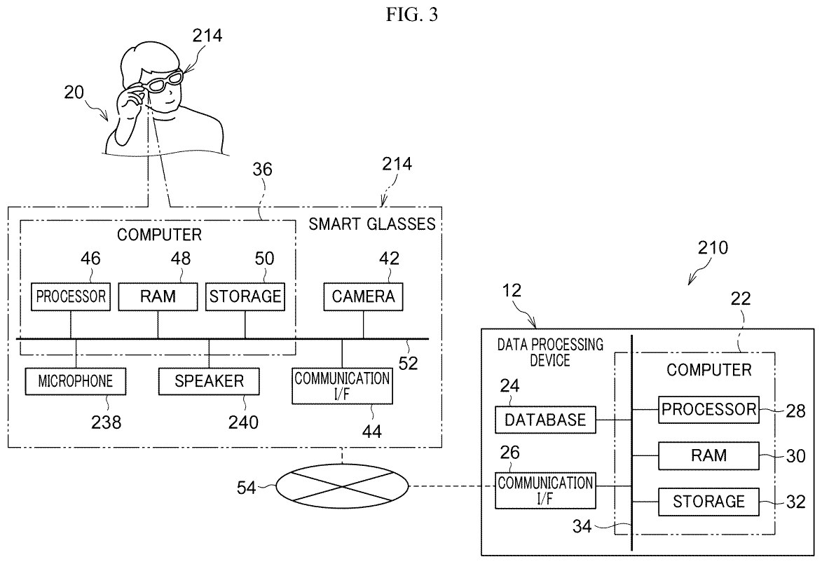

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

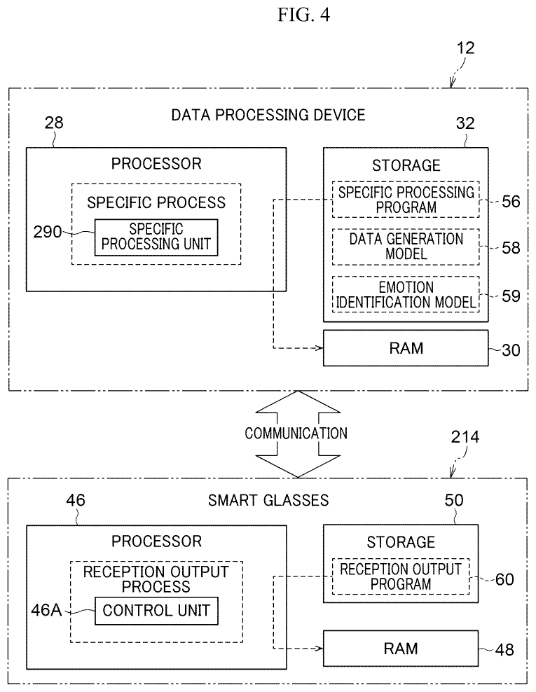

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### THIRD EXEMPLARY EMBODIMENT

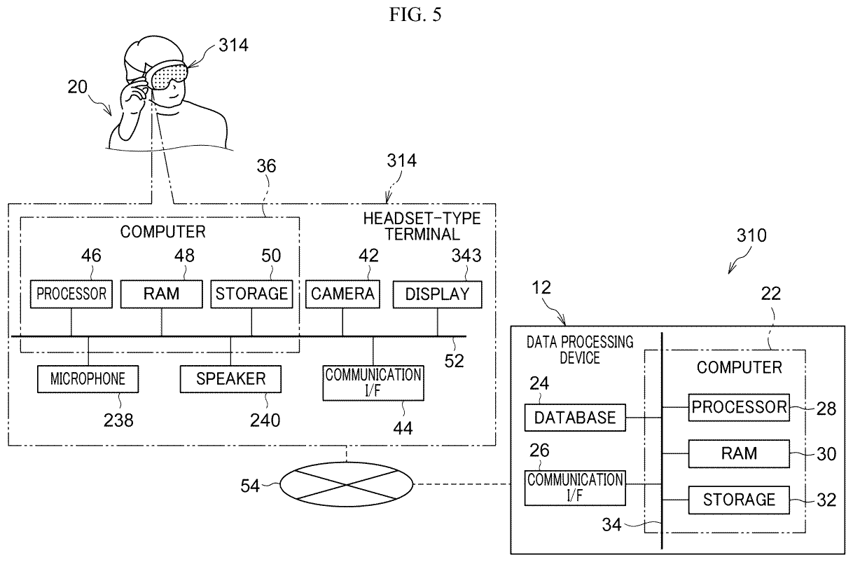

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

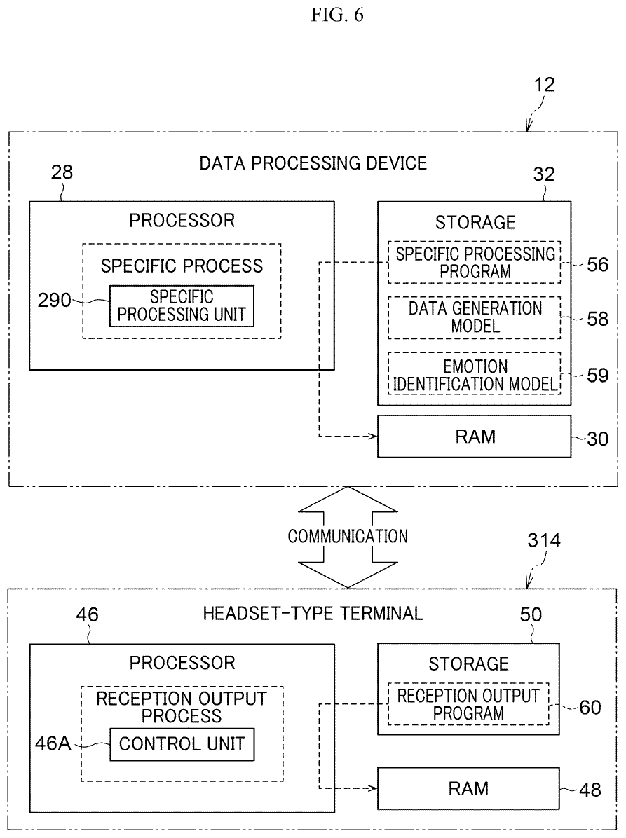

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### FOURTH EXEMPLARY EMBODIMENT

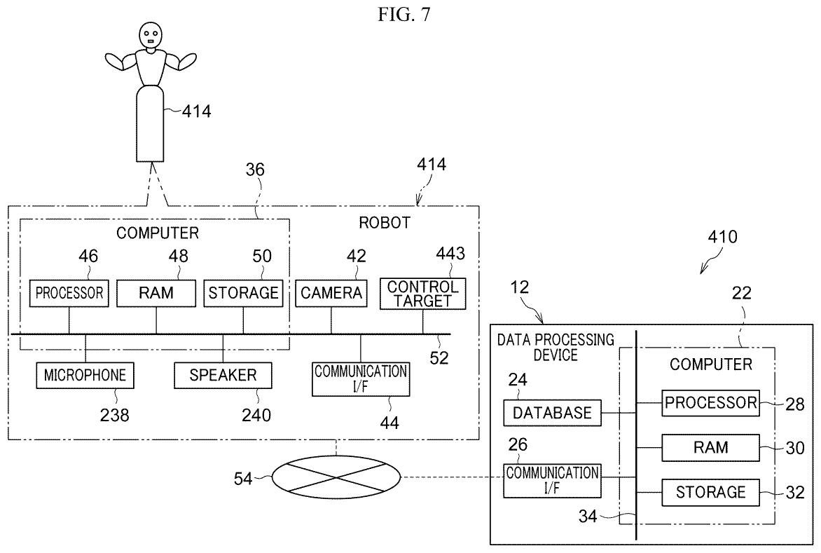

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

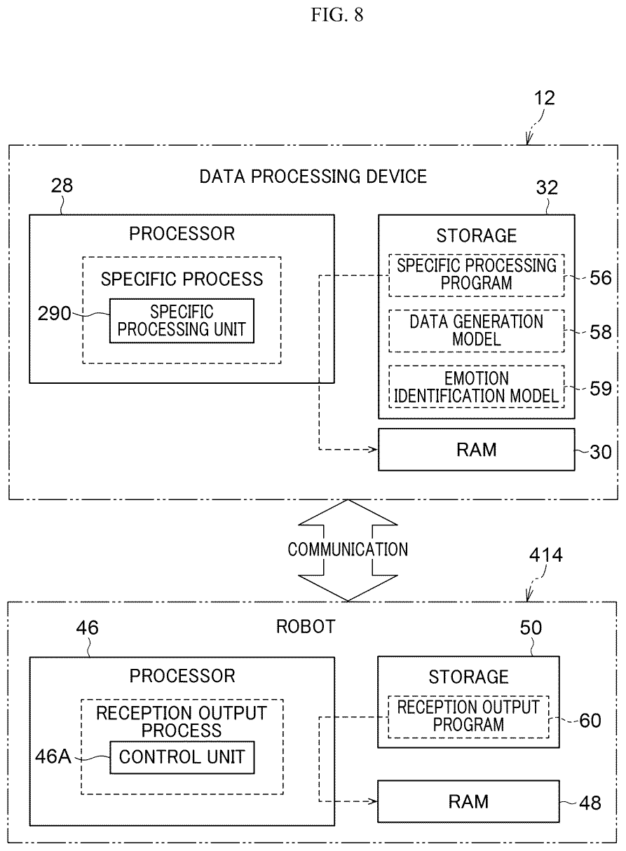

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

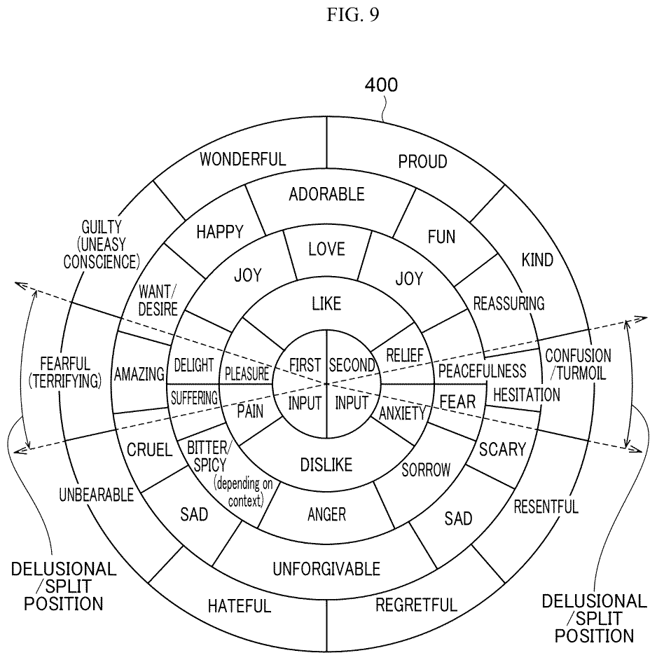

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

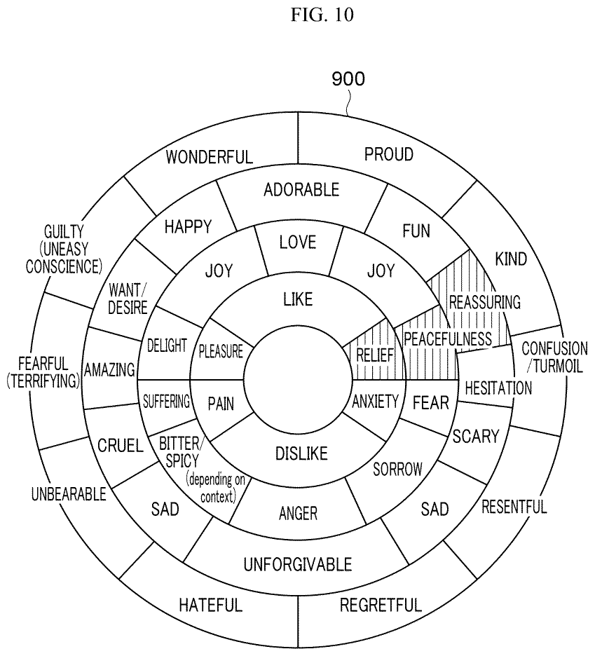

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive, via an input/output device, information materials input by a user as character-based information, and store the information materials in a storage device,
receive, via a sound collection device, voice information uttered by the user as audio data, and store the audio data in the storage device,
input the audio data to an information processing unit for speech recognition, generate character-based information corresponding to the audio data, and store the generated character-based information in the storage device,
perform acoustic analysis on the audio data by using an information processing unit, obtain volume information along a time axis, calculate statistical values including an average volume, a maximum volume, and a volume variation index from the volume information, and vectorize the statistical values as numerical data,
perform emotion analysis on the audio data by using an information processing unit, calculate as numerical data a plurality of emotion indices representing emotional states contained in the audio data, integrate the plurality of emotion indices with the numerical data relating to the volume, generate a numerical vector, and store the numerical vector in the storage device,
generate a prompt sentence for a generative AI model based on the information materials, the character-based information obtained by the speech recognition, and the numerical vector,
input the prompt sentence including the character-based information and the numerical vector to the generative AI model, and instruct the generative AI model to generate feedback information relating to content and speaking style, and
acquire the feedback information from the generative AI model, transmit the feedback information to a terminal device via a communication network, and format the feedback information into a displayable form for the user on the terminal device.

### (Supplementary 2)

The system according to supplementary 1,
wherein the processor is configured to divide the audio data into segments based on a predetermined time unit or a speech unit, calculate emotional states as numerical data for each of the segments, and include temporal changes of the emotional states corresponding to the segments in the numerical vector in a trackable format.

### (Supplementary 3)

The system according to supplementary 1,
wherein the processor is configured to structure, in the prompt sentence, a relationship between the information materials and the character-based information obtained by the speech recognition, and statistical values of the volume information and the emotion indices included in the numerical vector, as explanatory text and evaluation items interpretable by a human, so that the generative AI model generates concrete and quantitative feedback information relating to both the content and the speaking style based on the structured information.

### Application Example 1

### (Supplementary 1)

A system comprising a processor,
wherein the processor is configured to
provide an information acquisition unit that acquires character information as information material and voice information as utterance information, the character information and the voice information being input by a user via a terminal,
perform speech recognition processing by converting the acquired voice information into character information using an information processing service having a speech recognition function, execute analysis processing on the obtained character information using an external analysis service to calculate emotional states and volume states as numerical information, and generate a feature vector including emotional information and volume information as analysis results,
construct a prompt sentence, based on the character information of the information material acquired by the information acquisition unit, the character information obtained by the speech recognition processing, and the feature vector generated as the analysis results, the prompt sentence instructing a conversational information processing model to generate evaluation and improvement suggestions regarding content and speaking manner, and input the prompt sentence and the analysis results into the conversational information processing model so as to cause the conversational information processing model to generate feedback information, and
transmit the feedback information to the terminal and convert the feedback information into a presentation format that is displayable to the user via the terminal.

### (Supplementary 2)

The system according to supplementary 1,
wherein the processor is configured to
use the external analysis service to calculate a plurality of numerical values representing degrees of emotion for the character information obtained by the speech recognition processing, arrange the plurality of numerical values according to temporal transitions to generate an emotional state vector, incorporate numerical information representing the volume state into the feature vector, and provide the feature vector to a function that constructs the prompt sentence and causes the conversational information processing model to generate the feedback information.

### (Supplementary 3)

The system according to supplementary 1,
wherein the processor is configured to
dynamically change evaluation criteria and improvement items described in the prompt sentence to be given to the conversational information processing model, in accordance with value ranges of the emotional information and the volume information included in the feature vector, and cause the conversational information processing model to generate the feedback information including individualized and concrete advice regarding emotional expression and volume expression in the user's utterance.

### Example 2

### (Supplementary 1)

A system comprising a processor,
wherein the processor is configured to
receive, via an information input/output apparatus, information material data and audio data input by a user,
perform preprocessing on the information material data by extracting character information according to a format of the information material data, removing unnecessary information from the character information, and generating analysis character information,
perform preprocessing on the audio data by converting the audio data into a predetermined audio analysis format, reducing noise components, and generating analysis audio data, execute natural language processing on the analysis character information to identify phrase information, topic information, and section information and to generate text analysis information,
execute acoustic analysis on the analysis audio data to extract acoustic feature quantities, to calculate volume information, speaking rate information, fundamental frequency information, and time variation information, and to generate acoustic analysis information,
execute emotion analysis based on the acoustic feature quantities to estimate emotional states for respective time intervals, to generate time-series emotional state information, and to generate emotion analysis information,
associate, based on the section information, the text analysis information with the acoustic analysis information and the emotion analysis information in a time-aligned manner, and generate integrated analysis information in which content information and expression information are integrated for each section,
generate structured feedback information including content evaluation information and speaking-style evaluation information based on the integrated analysis information and statistical information,
create explanation-target data including the structured feedback information and the integrated analysis information, and generate a prompt sentence configured to instruct a generative AI model to generate a natural-language feedback text based on the explanation-target data,
input the prompt sentence and the explanation-target data into the generative AI model, and acquire the feedback text generated by the generative AI model, and
transmit the feedback text and the structured feedback information to the information input/output apparatus and cause the information input/output apparatus to present the feedback text and the structured feedback information to the user.

### (Supplementary 2)

The system according to supplementary 1,
wherein the processor is configured to
extract, from the integrated analysis information, the content evaluation information, the speaking-style evaluation information, and the time-series emotional state information,
summarize these as the explanation-target data, and generate the prompt sentence including a request to the generative AI model to describe relationships between emotional changes and topics and to present improvement guidelines.

### (Supplementary 3)

The system according to supplementary 1,
wherein the processor is configured to
receive an additional prompt sentence input by the user via the information input/output apparatus, combine the additional prompt sentence with the integrated analysis information, input the additional prompt sentence and the integrated analysis information into the generative AI model, acquire an additional feedback text corresponding to a request of the user, and cause the information input/output apparatus to present the additional feedback text to the user.

### Application Example 2

### (Supplementary 1)

A system comprising a processor,
wherein the processor is configured to
provide, on an information processing apparatus, a user interface through which a user inputs information materials and voice information; and
determine a file format of the information materials, extract character string information from the information materials by document analysis processing, and generate evaluation target text; and
convert the voice information into character string information by speech recognition processing, calculate acoustic feature quantities including volume, speaking speed, pitch, and temporal changes thereof by acoustic analysis processing, and structure the acoustic feature quantities as numerical data; and
perform emotion analysis processing based on the information materials and the voice information to generate an emotion vector indicating an emotional state of a listener or a speaker, and record the emotional state and temporal changes thereof as numerical data; and integrate the evaluation target text, the acoustic feature quantities, and the emotion vector as input information, convert the numerical data into a natural language expression, generate a prompt sentence including evaluation viewpoints and situation description, and construct the prompt sentence as input to a generative AI model; and
transmit the prompt sentence to the generative AI model, cause the generative AI model to generate feedback information including a content evaluation for the evaluation target text and an evaluation relating to speaking style and emotional expression based on the acoustic feature quantities and the emotion vector, and receive a generation result; and
extract or format, based on the generation result, an action-guiding feedback sentence indicating next utterance content of the user and adjustment methods for the volume, the speaking speed, and the emotional expression in a service scene or a presentation scene; and convert the action-guiding feedback sentence and the content evaluation into output data for display on a user display device, and transmit the output data to a terminal device so as to present the output data to the user in real time or after the scene.

### (Supplementary 2)

The system according to supplementary 1,
wherein the processor is configured to perform the emotion analysis processing by applying an emotion estimation algorithm to the voice information, calculate the emotion vector for each time interval to track a transition of the emotional state, and include the transition of the emotional state in the prompt sentence to provide the transition to the generative AI model.

### (Supplementary 3)

The system according to supplementary 1,
wherein the processor is configured to convert the output data such that the feedback information is summarized according to a display area of a wearable display device or a portable display device, and to transmit the output data to the terminal device such that short sentences visually recognizable by the user are sequentially displayed during customer service or during a presentation.

What is claimed is:

1. A system comprising:
circuitry configured to:
receive, via a communication interface coupled to a packet-switched network, content data comprising text data associated with reference material and audio data captured from a user terminal device;
perform speech recognition processing on the audio data to generate recognized text data;
extract acoustic feature data from the audio data, the acoustic feature data comprising volume statistics along a time axis and a plurality of emotion indices derived from emotion analysis of the audio data;
generate a numerical vector by vectorizing the volume statistics and the plurality of emotion indices;
generate a prompt data structure by combining the text data, the recognized text data, and the numerical vector into an input sequence for a generative neural network model; and
transmit, via the communication interface, feedback data generated by the generative neural network model based on the prompt data structure, the feedback data comprising evaluation information associated with at least content quality and delivery characteristics, to the user terminal device as a notification data packet.

2. The system according to claim 1, wherein the volume statistics comprise an average volume value, a maximum volume value, and a volume variation index computed over the time axis.

3. The system according to claim 2, wherein the volume variation index comprises a standard deviation or a coefficient of variation of volume measurements sampled at predetermined time intervals along the time axis.

4. The system according to claim 1, wherein the plurality of emotion indices comprise scores for a plurality of emotion categories, and wherein the circuitry is configured to determine a dominant emotion category based on a highest score among the plurality of emotion categories.

5. The system according to claim 4, wherein the plurality of emotion categories comprise at least three of: joy, anger, sadness, surprise, fear, disgust, or neutral.

6. The system according to claim 4, wherein the circuitry is further configured to perform segment-based emotion tracking by dividing the audio data into a plurality of temporal segments and computing the plurality of emotion indices for each temporal segment, generating an emotion trajectory over the time axis.

7. The system according to claim 1, wherein the circuitry is further configured to generate the recognized text data by inputting the audio data into a speech recognition model that outputs text with associated timestamp data, enabling alignment of the recognized text data with the acoustic feature data along the time axis.

8. The system according to claim 1, wherein the prompt data structure comprises a structured template including a plurality of evaluation items, each evaluation item associated with a respective portion of the numerical vector and a corresponding segment of the recognized text data.

9. The system according to claim 8, wherein the plurality of evaluation items comprise at least content coherence, speaking pace, volume appropriateness, and emotional expressiveness.

10. The system according to claim 1, wherein the circuitry is further configured to invoke an external analysis service via the communication interface to perform at least one of the emotion analysis or the speech recognition processing, and to receive analysis result data from the external analysis service.

11. The system according to claim 1, wherein the generative neural network model comprises a large language model, and wherein the prompt data structure further comprises instruction text specifying an evaluation format and a scoring rubric for the feedback data.

12. The system according to claim 1, wherein the feedback data comprises a numerical score for each of the content quality and the delivery characteristics, and textual commentary identifying specific segments of the recognized text data associated with improvement recommendations.

13. The system according to claim 12, wherein the improvement recommendations reference specific temporal positions along the time axis where the acoustic feature data deviates from a predetermined threshold range.

14. The system according to claim 1, wherein the circuitry is further configured to perform a real-time emotion analysis operation by continuously processing segments of the audio data as the audio data is received, and transmitting intermediate emotion index data to the user terminal device before the audio data is fully received.

15. The system according to claim 1, wherein the text data associated with the reference material comprises at least one of slide text data extracted from a presentation file or document text data provided by a user.

16. The system according to claim 1, wherein the circuitry is further configured to compare the recognized text data against the text data associated with the reference material to determine a coverage ratio indicating a proportion of the reference material addressed in the audio data.

17. The system according to claim 1, wherein extracting the acoustic feature data further comprises computing a speaking rate metric based on a count of recognized words per unit time derived from the recognized text data and associated timestamp information.

18. A system comprising:
circuitry configured to:
receive, via a communication interface coupled to a packet-switched network, content data comprising text data and audio data from a terminal device;
convert the audio data to recognized text data using speech recognition;
extract acoustic feature data from the audio data, the acoustic feature data comprising volume statistics including an average volume, a maximum volume, and a volume variation index, and a plurality of emotion indices;
generate a numerical vector by vectorizing the volume statistics and the plurality of emotion indices into a multidimensional feature representation;
construct a prompt data structure by combining the text data, the recognized text data, and the numerical vector, the prompt data structure comprising a structured template with a plurality of evaluation items; and
transmit feedback data generated by a generative neural network model based on the prompt data structure to the terminal device as a notification data packet via the communication interface.

19. The system according to claim 18, wherein the circuitry is further configured to perform segment-based emotion tracking by dividing the audio data into temporal segments and computing the plurality of emotion indices per segment, and wherein the prompt data structure further comprises an emotion trajectory derived from the segment-based emotion tracking.

20. A method performed by circuitry of a system, the method comprising:
receiving, via a communication interface coupled to a packet-switched network, content data comprising text data and audio data;
performing speech recognition processing on the audio data to generate recognized text data;
extracting acoustic feature data from the audio data, the acoustic feature data comprising volume statistics along a time axis and a plurality of emotion indices;
generating a numerical vector by vectorizing the volume statistics and the plurality of emotion indices;
generating a prompt data structure by combining the text data, the recognized text data, and the numerical vector into an input sequence for a generative neural network model; and
transmitting feedback data generated by the generative neural network model based on the prompt data structure as a notification data packet via the communication interface.
